(19) United States
(12) Patent Application Publication
(10) Pub. No.: US 2020/0400778 A1
(43) Pub. Date: Dec. 24, 2020

(54) RECEIVER DIVERSITY FOR WI-FI SENSING

(71) Applicants: Claudio da Silva, Portland, OR (US); Carlos Cordeiro, Portland, OR (US); Bahar Sadegh, Portland, OR (US); Cheng Chen, Portland, OR (US); Artyom Lomayev, Nizhny Novgorod (RU); Ganesh Venkatesan, Hillsboro, OR (US); Preston Hunt, Portland, OR (US)

(72) Inventors: Claudio da Silva, Portland, OR (US); Carlos Cordeiro, Portland, OR (US); Bahar Sadegh, Portland, OR (US); Cheng Chen, Portland, OR (US); Artyom Lomayev, Nizhny Novgorod (RU); Ganesh Venkatesan, Hillsboro, OR (US); Preston Hunt, Portland, OR (US)

(21) Appl. No.: 17/012,951

(22) Filed: Sep. 4, 2020

Related U.S. Application Data
(60) Provisional application No. 62/896,975, filed on Sep. 6, 2019.

(51) Int. Cl. G01S 7/00; H04L 25/02; G01S 13/00; G01S 13/56

(52) U.S. Cl. CPC G01S 7/006; H04L 25/021; H04W 84/12; G01S 13/003; G01S 13/56; H04L 25/0204

(57) ABSTRACT

This disclosure describes systems, methods, and devices related to receiver diversity for Wi-Fi sensing. A device may identify first packets received from a second device during a time period, the first packets received using a first communication link between the device and the second device, and may identify second packets received from a third device during the time period, the second packets received using a second communication link between the device and the third device. The device may determine, based on the first packets, a first value indicative of a first amount of channel state variance associated with the first communication link during the time period. The device may determine, based on the second packets, a second value indicative of a second amount of channel state variance associated with the second communication link during the time period. The device may send the first value and the second value.

### CROSS-REFERENCE TO RELATED APPLICATION

This application is related to and claims priority to U.S. Provisional Patent Application No. 62/896,975, filed Sep. 6, 2019, which is hereby incorporated herein by reference in its entirety.

### TECHNICAL FIELD

This disclosure generally relates to systems and methods for wireless communications and, more particularly, to receiver diversity for Wi-Fi sensing.

### BACKGROUND

Wireless devices are becoming widely prevalent and are increasingly requesting access to wireless channels. The Institute of Electrical and Electronics Engineers (IEEE) is developing one or more standards that utilize Orthogonal Frequency-Division Multiple Access (OFDMA) in channel allocation.

### BRIEF DESCRIPTION OF THE DRAWINGS

FIG. 1 is a network diagram illustrating an example network environment for receiver diversity for Wi-Fi sensing, in accordance with one or more example embodiments of the present disclosure.

FIG. 2 depicts an illustrative system for receiver diversity for Wi-Fi sensing, in accordance with one or more example embodiments of the present disclosure.

FIG. 3A depicts an illustrative graph for receiver diversity for Wi-Fi sensing, in accordance with one or more example embodiments of the present disclosure.

FIG. 3B depicts an illustrative graph for receiver diversity for Wi-Fi sensing, in accordance with one or more example embodiments of the present disclosure.

FIG. 3C depicts an illustrative graph for receiver diversity for Wi-Fi sensing, in accordance with one or more example embodiments of the present disclosure.

FIG. 3D depicts an illustrative graph for receiver diversity for Wi-Fi sensing, in accordance with one or more example embodiments of the present disclosure.

FIG. 4A depicts an illustrative graph for receiver diversity for Wi-Fi sensing, in accordance with one or more example embodiments of the present disclosure.

FIG. 4B depicts an illustrative graph for receiver diversity for Wi-Fi sensing, in accordance with one or more example embodiments of the present disclosure.

FIG. 4C depicts an illustrative graph for receiver diversity for Wi-Fi sensing, in accordance with one or more example embodiments of the present disclosure.

FIG. 5A depicts an illustrative system for receiver diversity for Wi-Fi sensing, in accordance with one or more example embodiments of the present disclosure.

FIG. 5B depicts an illustrative system for receiver diversity for Wi-Fi sensing, in accordance with one or more example embodiments of the present disclosure.

FIG. 6A is a network diagram illustrating an example network environment for receiver diversity for Wi-Fi sensing, in accordance with one or more example embodiments of the present disclosure.

FIG. 6B is a network diagram illustrating an example network environment for receiver diversity for Wi-Fi sensing, in accordance with one or more example embodiments of the present disclosure.

FIG. 7 illustrates a flow diagram of illustrative process for an illustrative receiver diversity for Wi-Fi sensing system, in accordance with one or more example embodiments of the present disclosure.

FIG. 8 illustrates a functional diagram of an exemplary communication station that may be suitable for use as a user device, in accordance with one or more example embodiments of the present disclosure.

FIG. 9 illustrates a block diagram of an example machine upon which any of one or more techniques (e.g., methods) may be performed, in accordance with one or more example embodiments of the present disclosure.

FIG. 10 is a block diagram of a radio architecture in accordance with some examples.

FIG. 11 illustrates an example front-end module circuitry for use in the radio architecture of FIG. 10, in accordance with one or more example embodiments of the present disclosure.

FIG. 12 illustrates an example radio IC circuitry for use in the radio architecture of FIG. 10, in accordance with one or more example embodiments of the present disclosure.

FIG. 13 illustrates an example baseband processing circuitry for use in the radio architecture of FIG. 10, in accordance with one or more example embodiments of the present disclosure.

### DETAILED DESCRIPTION

The following description and the drawings sufficiently illustrate specific embodiments to enable those skilled in the art to practice them. Other embodiments may incorporate structural, logical, electrical, process, algorithm, and other changes. Portions and features of some embodiments may be included in, or substituted for, those of other embodiments. Embodiments set forth in the claims encompass all available equivalents of those claims.

Wi-Fi sensing is a term given to technologies that use traditional Wi-Fi to passively perform radar-like applications such as detecting motion in a room. Wi-Fi sensing allows for motion detection, gesture recognition, and biometric measurements using Wi-Fi signals. Sensing is performed by tracking channel estimates obtained with multiple Wi-Fi packets (e.g., physical layer protocol data units—PPDUs) over time, and detecting changes that may indicate an event of interest (e.g., whether motion is present).

In some Wi-Fi sensing applications, sensing measurements are performed by a single STA, which may be an access point (AP). When measurements are taken by a non-AP STA, typically only one communication link is tracked (specifically, the link from the non-AP STA to an AP) and channel measurements may be taken by a single STA. This is because the IEEE 802.11 standard currently does not include mechanisms that efficiently support Wi-Fi sensing applications.

In Wi-Fi sensing (or wireless local area network sensing—WLAN sensing), sensing (e.g., motion sensing) may be performed by tracking changes/variations in channel estimates obtained with multiple Wi-Fi packets over time—which could have been sent by one or more devices—and detecting patterns that indicate an event of interest, such as motion in a room. For example, channel state information (CSI) may refer to information that characterizes the propagation of wireless signals from a transmitter to a receiver at different carrier frequencies. A channel frequency response (CFR) may represent a CSI entry, including an amplitude and phase of a wireless signal. CSI may be based on the carrier frequency (e.g., different carrier frequencies may have different CFRs), propagation delay, and an amplitude attenuation factor. A CSI amplitude and phase may be affected by movements of transmitter and/or receiver devices, objects, and people. As such, when a CSI (e.g., a CFR) varies over time, such may indicate the presence and motion of people or objects. In this manner, the variance of CSI channel measurements for a communication link over time may indicate the presence of motion.

In modern Wi-Fi applications, a Wi-Fi channel using multiple input, multiple output (MIMO) may be divided into subcarriers using OFDMA. With many subcarriers to cover a large frequency range, the sending of channel measurements (e.g., CSI) between devices may require a significant load on a network.

Accordingly, channel estimate variation observed over time in Wi-Fi sensing is typically measured/characterized by an “E-metric,” which may be a metric indicative of channel variance over time. The sending of E-metrics for respective links may reduce network load when compared to sending CSI for a significant number of subcarriers. For example, the E-metric may be defined by one or more eigenvalues of a covariance matrix of channel estimates obtained over time, although the E-metric is not limited to such value. The larger the variance in a channel measurement over time for a given communication link, the larger the probability of motion between the devices that use the communication link.

Consider, for example, the following example. The E-metrics of a channel between STA 1 and STA 2 and between STA 3 and STA 2 may be measured by STA 2 (e.g., STA 2 is a common receiver to both links). In one scenario, there may be no motion, indicated by small E-metric values (e.g., below a threshold value) for both links. In another scenario, there may be motion only in one location (e.g., a room in which STA 1 is located), indicated by large E-metric values for a first link between STA 1 and STA2, and a small E-metric value for a second link between STA 3 and STA 2, indicating motion somewhere in the first link, but no motion in the second link. In another scenario, there may be motion in a second location only (e.g., a room in which STA 3 is located), indicated by small E-metric values for the first link and a large E-metric value for the second link, indicating motion somewhere in the second link, but no motion in the first link. In another scenario, there may be motion in a third location only (e.g., a room in which STA 2 is located), indicated by large E-metric values for both the first and second links, indicating motion that impacts both links (e.g., motion close to the common receiver of both links).

Wi-Fi sensing with a single receiver (e.g., STA 2 in the example above) may be able to identify accurately each of the scenarios described above (e.g., no motion, or motion in one of the locations associated with a single link) because the pattern of changes (e.g., E-metrics) represented by channel measurements in the first and second links may be distinct. However, the two links described in the example above may not sufficient to accurately distinguish and classify more complex scenarios, such as the detection of motion in multiple locations. As a result, some Wi-Fi sensing applications (e.g., relying on a single sensing receiver device) may not be able to accurately distinguish the identified movement patterns of scenarios with movement in multiple locations.

There are a multiple ways to detect motion in multiple locations. One solution, for example, would be to use a fourth device in the environment. If the fourth device is positioned at a convenient location, an additional link with the fourth device may be used to differentiate the patterns of motion previously described in the above example. However, requiring Wi-Fi sensing users to deploy additional devices to support such applications may not be convenient to users. Instead, in addition to taking measurements with the STA 2, STA 1 also may be able to take measurements (e.g., multiple devices performing channel variance measurements). This scenario may allow for sensing measurements to be performed by STA 2 to reliably detect the scenario with no motion, the scenario with motion only in the location of STA 1, and the scenario with motion only in the location of STA 3, but not the other patterns (e.g., where motion occurs in multiple locations). When the device taking measurements is STA 1, sensing measurements may allow for reliable detection of the scenarios with no motion, with motion only in the location of STA 3, and the scenario with motion only in the location of STA 2, but not the other scenarios (e.g., where motion occurs in multiple locations).

While increasing the number of transmitters (but still using just one receiver) results in more data (and, thus, possibly improved performance), the data may be biased due to the transmitters all having the same common receiver. For the same network with STA 1, STA 2, and STA 3, measurements taken by different stations may have different statistical characteristics.

Therefore, an improvement caused by increasing the number of “sensing receivers” may be greater than an improvement caused by increasing the number of transmitters.

Example embodiments of the present disclosure relate to systems, methods, and devices for receiver diversity for Wi-Fi sensing applications.

In one or more embodiments, a receiver diversity for Wi-Fi sensing system may facilitate a procedure that may greatly improve Wi-Fi sensing by means of exploiting the fact that sensing is heavily biased by the location of the STA that performs sensing measurements. Specifically, the receiver diversity for a Wi-Fi sensing system may facilitate a procedure in which two or more STAs assume the role of “sensing receiver” either in a time-division manner or at the same time. By doing so, sensing measurements may achieve “receiver diversity” and different statistical characteristics that, when appropriately used, allow for improved performance.

In one or more embodiments, because statistical characteristics of Wi-Fi sensing measurements may change greatly depending on which device within a basic service set (BSS) obtains the measurements, and because the number of targets and the location of targets may be unknown, Wi-Fi sensing protocols may allow for sensing measurements to be performed by one or more devices within the BSS.

In one or more embodiments, the STA that starts the Wi-Fi sensing procedure and takes measurements may be the AP. The AP, for example, may “ping” each device within the BSS and detect movement by continuously estimating the various channels by using the packets transmitted by the different devices.

In one or more embodiments, an “initiator/sensing receiver” (e.g., a non-AP STA) may request the AP to schedule transmission intervals for the devices in the BSS. At the scheduled intervals, the various devices within the BSS may transmit packets that are used by the “initiator/sensing receiver” to estimate the various channels. By tracking the packets received over multiple “sensing intervals” scheduled by the AP, the initiator/sensing receiver may be able to track channel variations and to perform Wi-Fi sensing. In this manner, a non-AP STA of the BSS may be the device performing sensing measurements.

In one or more embodiments, an AP may schedule transmission intervals in such a way that Wi-Fi sensing measurements may be performed by multiple devices—either at the same time or in a time multiplexed manner. For example, there may be a scenario with two sensing intervals. In the first sensing interval, transmissions may be made by STA 1 and STA 3 as described above, and measurements are made by STA 2. In the second sensing interval, transmissions may be made by STA 3 and STA 2, and measurements are made by STA 1. Measurements taken during each of the two sensing intervals have different characteristics due to the fact that they are obtained by different devices. Therefore, Wi-Fi sensing performance may be improved by combining results obtained by multiple receivers. Once measurements are made by different STAs, measurements (either “raw” or a compressed version) may be transmitted to an “entity” that will collect and combine/fuse them. The “entity” may be one of the STAs that either transmitted or received “sensing packets” (or both), a STA within the BSS that did not transmit or receive “sensing packets,” or an application running, for example, in a cloud network. In this cloud network case, measurements may be sent to the AP which, in turn, may forward the measurements to the appropriate destination.

Combining sensing measurements performed by more than one STA may result in improved probabilities of correct classification when compared to relying on sensing measurements taken by a device at one location only. The improvement may be from 80% or 74% probabilities of two single locations to a probability of 94% when the measurements are performed by receivers in both locations and are combined.

The above descriptions are for purposes of illustration and are not meant to be limiting. Numerous other examples, configurations, processes, algorithms, etc., may exist, some of which are described in greater detail below. Example embodiments will now be described with reference to the accompanying figures.

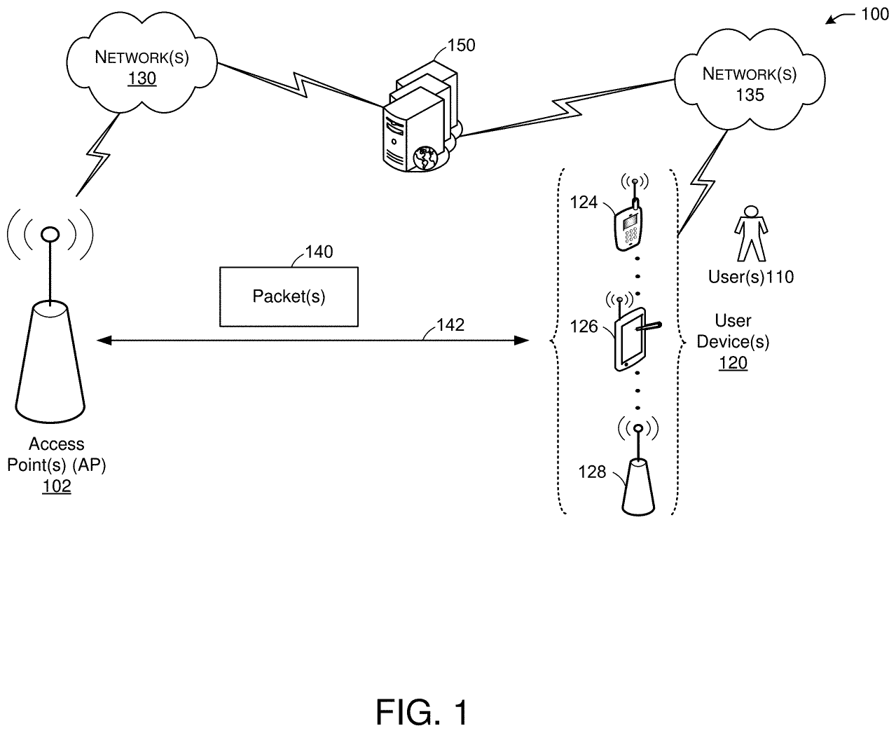

FIG. 1 is a network diagram illustrating an example network environment of receiver diversity for Wi-Fi sensing, according to some example embodiments of the present disclosure. Wireless network 100 may include one or more user devices 120 and one or more access points(s) (AP) 102, which may communicate in accordance with IEEE 802.11 communication standards. The user device(s) 120 may be mobile devices that are non-stationary (e.g., not having fixed locations) or may be stationary devices.

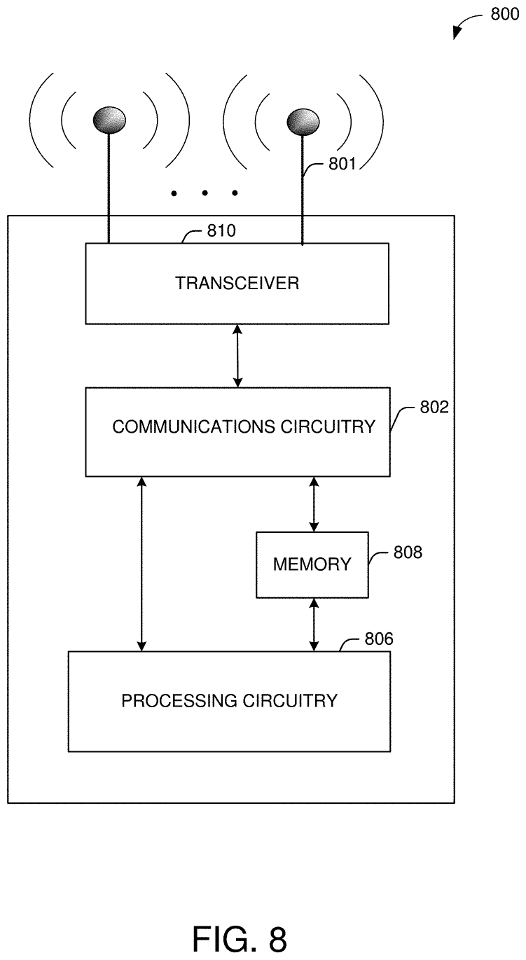

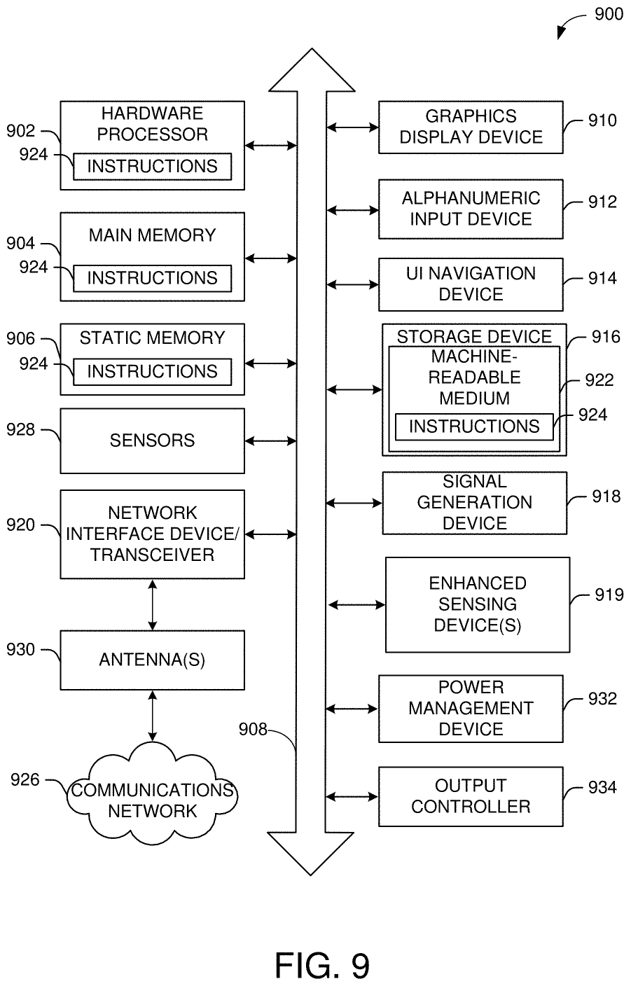

In some embodiments, the user devices 120 and the AP 102 may include one or more computer systems similar to that of the functional diagram of FIG. 8 and/or the example machine/system of FIG. 9.

One or more illustrative user device(s) 120 and/or AP(s) 102 may be operable by one or more user(s) 110. It should be noted that any addressable unit may be a station (STA). An STA may take on multiple distinct characteristics, each of which shape its function. For example, a single addressable unit might simultaneously be a portable STA, a quality-of-service (QoS) STA, a dependent STA, and a hidden STA. The one or more illustrative user device(s) 120 and the AP(s) 102 may be STAs. The one or more illustrative user device(s) 120 and/or AP(s) 102 may operate as a personal basic service set (PBSS) control point/access point (PCP/AP). The user device(s) 120 (e.g., 124, 126, or 128) and/or AP(s) 102 may include any suitable processor-driven device including, but not limited to, a mobile device or a non-mobile, e.g., a static device. For example, user device(s) 120 and/or AP(s) 102 may include, a user equipment (UE), a station (STA), an access point (AP), a software enabled AP (SoftAP), a personal computer (PC), a wearable wireless device (e.g., bracelet, watch, glasses, ring, etc.), a desktop computer, a mobile computer, a laptop computer, an Ultrabook™ computer, a notebook computer, a tablet computer, a server computer, a handheld computer, a handheld device, an internet of things (IoT) device, a sensor device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “carry small live large” (CSLL) device, an ultra mobile device (UMD), an ultra mobile PC (UMPC), a mobile internet device (MID), an “origami” device or computing device, a device that supports dynamically composable computing (DCC), a context-aware device, a video device, an audio device, an A/V device, a set-top-box (STB), a blu-ray disc (BD) player, a BD recorder, a digital video disc (DVD) player, a high definition (HD) DVD player, a DVD recorder, a HD DVD recorder, a personal video recorder (PVR), a broadcast HD receiver, a video source, an audio source, a video sink, an audio sink, a stereo tuner, a broadcast radio receiver, a flat panel display, a personal media player (PMP), a digital video camera (DVC), a digital audio player, a speaker, an audio receiver, an audio amplifier, a gaming device, a data source, a data sink, a digital still camera (DSC), a media player, a smartphone, a television, a music player, or the like. Other devices, including smart devices such as lamps, climate control, car components, household components, appliances, etc. may also be included in this list.

As used herein, the term “Internet of Things (IoT) device” is used to refer to any object (e.g., an appliance, a sensor, etc.) that has an addressable interface (e.g., an Internet protocol (IP) address, a Bluetooth identifier (ID), a near-field communication (NFC) ID, etc.) and can transmit information to one or more other devices over a wired or wireless connection. An IoT device may have a passive communication interface, such as a quick response (QR) code, a radio-frequency identification (RFID) tag, an NFC tag, or the like, or an active communication interface, such as a modem, a transceiver, a transmitter-receiver, or the like. An IoT device can have a particular set of attributes (e.g., a device state or status, such as whether the IoT device is on or off, open or closed, idle or active, available for task execution or busy, and so on, a cooling or heating function, an environmental monitoring or recording function, a light-emitting function, a sound-emitting function, etc.) that can be embedded in and/or controlled/monitored by a central processing unit (CPU), microprocessor, ASIC, or the like, and configured for connection to an IoT network such as a local ad-hoc network or the Internet. For example, IoT devices may include, but are not limited to, refrigerators, toasters, ovens, microwaves, freezers, dishwashers, dishes, hand tools, clothes washers, clothes dryers, furnaces, air conditioners, thermostats, televisions, light fixtures, vacuum cleaners, sprinklers, electricity meters, gas meters, etc., so long as the devices are equipped with an addressable communications interface for communicating with the IoT network. IoT devices may also include cell phones, desktop computers, laptop computers, tablet computers, personal digital assistants (PDAs), etc. Accordingly, the IoT network may be comprised of a combination of “legacy” Internet-accessible devices (e.g., laptop or desktop computers, cell phones, etc.) in addition to devices that do not typically have Internet-connectivity (e.g., dishwashers, etc.).

The user device(s) 120 and/or AP(s) 102 may also include mesh stations in, for example, a mesh network, in accordance with one or more IEEE 802.11 standards and/or 3GPP standards.

Any of the user device(s) 120 (e.g., user devices 124, 126, 128), and AP(s) 102 may be configured to communicate with each other via one or more communications networks 130 and/or 135 wirelessly or wired. The user device(s) 120 may also communicate peer-to-peer or directly with each other with or without the AP(s) 102. Any of the communications networks 130 and/or 135 may include, but not limited to, any one of a combination of different types of suitable communications networks such as, for example, broadcasting networks, cable networks, public networks (e.g., the Internet), private networks, wireless networks, cellular networks, or any other suitable private and/or public networks. Further, any of the communications networks 130 and/or 135 may have any suitable communication range associated therewith and may include, for example, global networks (e.g., the Internet), metropolitan area networks (MANs), wide area networks (WANs), local area networks (LANs), or personal area networks (PANs). In addition, any of the communications networks 130 and/or 135 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

Any of the user device(s) 120 (e.g., user devices 124, 126, 128) and AP(s) 102 may include one or more communications antennas. The one or more communications antennas may be any suitable type of antennas corresponding to the communications protocols used by the user device(s) 120 (e.g., user devices 124, 126 and 128), and AP(s) 102. Some non-limiting examples of suitable communications antennas include Wi-Fi antennas, Institute of Electrical and Electronics Engineers (IEEE) 802.11 family of standards compatible antennas, directional antennas, non-directional antennas, dipole antennas, folded dipole antennas, patch antennas, multiple-input multiple-output (MIMO) antennas, omnidirectional antennas, quasi-omnidirectional antennas, or the like. The one or more communications antennas may be communicatively coupled to a radio component to transmit and/or receive signals, such as communications signals to and/or from the user devices 120 and/or AP(s) 102.

Any of the user device(s) 120 (e.g., user devices 124, 126, 128), and AP(s) 102 may be configured to perform directional transmission and/or directional reception in conjunction with wirelessly communicating in a wireless network. Any of the user device(s) 120 (e.g., user devices 124, 126, 128), and AP(s) 102 may be configured to perform such directional transmission and/or reception using a set of multiple antenna arrays (e.g., DMG antenna arrays or the like). Each of the multiple antenna arrays may be used for transmission and/or reception in a particular respective direction or range of directions. Any of the user device(s) 120 (e.g., user devices 124, 126, 128), and AP(s) 102 may be configured to perform any given directional transmission towards one or more defined transmit sectors. Any of the user device(s) 120 (e.g., user devices 124, 126, 128), and AP(s) 102 may be configured to perform any given directional reception from one or more defined receive sectors.

MIMO beamforming in a wireless network may be accomplished using RF beamforming and/or digital beamforming. In some embodiments, in performing a given MIMO transmission, user devices 120 and/or AP(s) 102 may be configured to use all or a subset of its one or more communications antennas to perform MIMO beamforming.

Any of the user devices 120 (e.g., user devices 124, 126, 128), and AP(s) 102 may include any suitable radio and/or transceiver for transmitting and/or receiving radio frequency (RF) signals in the bandwidth and/or channels corresponding to the communications protocols utilized by any of the user device(s) 120 and AP(s) 102 to communicate with each other. The radio components may include hardware and/or software to modulate and/or demodulate communications signals according to pre-established transmission protocols. The radio components may further have hardware and/or software instructions to communicate via one or more Wi-Fi and/or Wi-Fi direct protocols, as standardized by the Institute of Electrical and Electronics Engineers (IEEE) 802.11 standards. In certain example embodiments, the radio component, in cooperation with the communications antennas, may be configured to communicate via 2.4 GHz channels (e.g., 802.11b, 802.11g, 802.11n, 802.11ax), 5 GHz channels (e.g., 802.11n, 802.11ac, 802.11ax), or 60 GHZ channels (e.g., 802.11ad, 802.11ay). 800 MHz channels (e.g., 802.11ah). The communications antennas may operate at 28 GHz and 40 GHz. It should be understood that this list of communication channels in accordance with certain 802.11 standards is only a partial list and that other 802.11 standards may be used (e.g., Next Generation Wi-Fi, or other standards). In some embodiments, non-Wi-Fi protocols may be used for communications between devices, such as Bluetooth, dedicated short-range communication (DSRC), Ultra-High Frequency (UHF) (e.g., IEEE 802.11af, IEEE 802.22), white band frequency (e.g., white spaces), or other packetized radio communications. The radio component may include any known receiver and baseband suitable for communicating via the communications protocols. The radio component may further include a low noise amplifier (LNA), additional signal amplifiers, an analog-to-digital (A/D) converter, one or more buffers, and digital baseband.

In one embodiment, and with reference to FIG. 1, AP 102 may facilitate receiver diversity for Wi-Fi sensing with one or more user devices 120. For example, the AP 102 and the one or more user devices 120 may exchange packets 140 (e.g., PPDUs), which may include a negotiation between the AP 102 and the one or more user devices 120, and/or may include channel measurement frames, and/or channel measurement reports used to perform Wi-Fi sensing. The packets 140 may include CSI and/or a value (e.g., E-metric) indicative of channel variance over time. For example, the packets 140 may be sent over one or more communication links 142 (e.g., a respective link between any two devices), and any of the one or more communication links 142 may experience CSI variance over time (e.g., as determined by the AP 102, the one or more user devices 120, and/or one or more cloud servers 150 based on the transmission of multiple packets over a given link over time). Any of the AP 102, the one or more user devices 120, and/or one or more cloud servers 150 may determine CSI variance of link of the one or more communication links 142 over time, and may generate the value indicating the CSI variance in the respective link. As explained further herein, any of the AP 102, the one or more user devices 120, and/or one or more cloud servers 150 may collect the channel variance values determined by multiple devices, and may use the channel variance values to determine whether motion occurred anywhere along the one or more communication links 142.

In one embodiment, and with reference to FIG. 1, AP 102 may communicate with the one or more cloud servers 150 using the one or more communications networks 130, and the one or more user devices 120 may communicate with one or more cloud servers 150 using the one or more communications networks 135. The AP 102 and/or the one or more user devices 120 may send CSI or the channel variance values to the one or more cloud servers 150 for analysis (e.g., to determine the presence of motion).

It is understood that the above descriptions are for purposes of illustration and are not meant to be limiting.

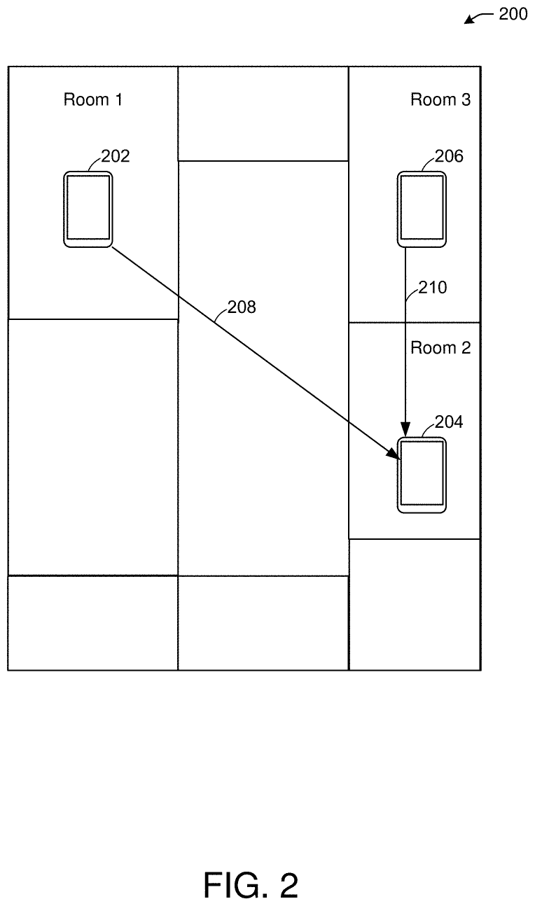

FIG. 2 depicts an illustrative system 200 for receiver diversity for Wi-Fi sensing, in accordance with one or more example embodiments of the present disclosure.

Referring to FIG. 2, the system 200 includes multiple devices in different rooms (e.g., physical locations) of a home. STA 202 is shown in room 1 (e.g., an office). STA 204 is shown in room 2 (e.g., bedroom 1). STA 206 is shown in room 3 (e.g., a play room). STA 202 and STA 206 may be sensing transmitters that may determine and transmit packets (e.g., the packets 140 of FIG. 1) to STA 204 (e.g., a sensing receiver). For example, STA 202 may send packets to STA 204 using communication link 208, and STA 206 may send packets to STA 204 using communication link 210.

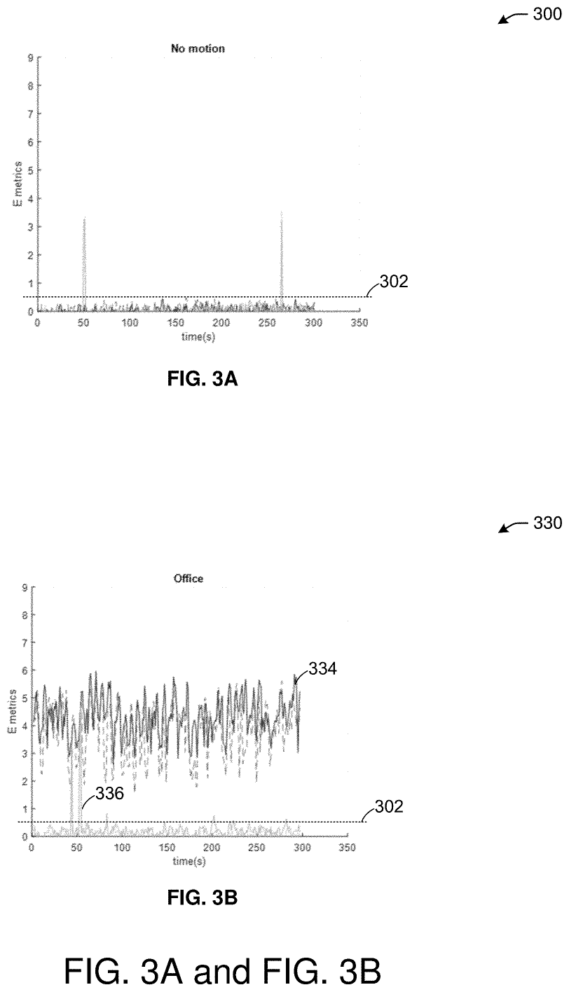

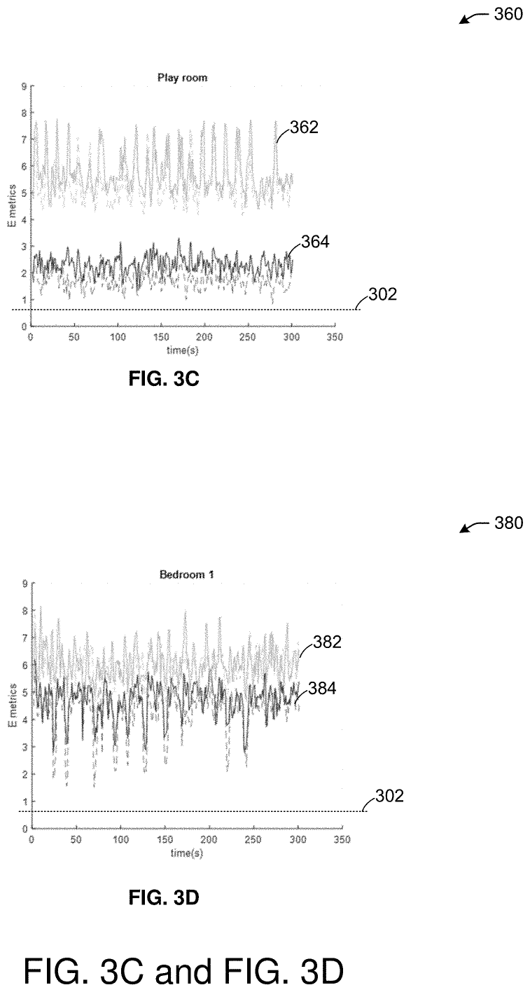

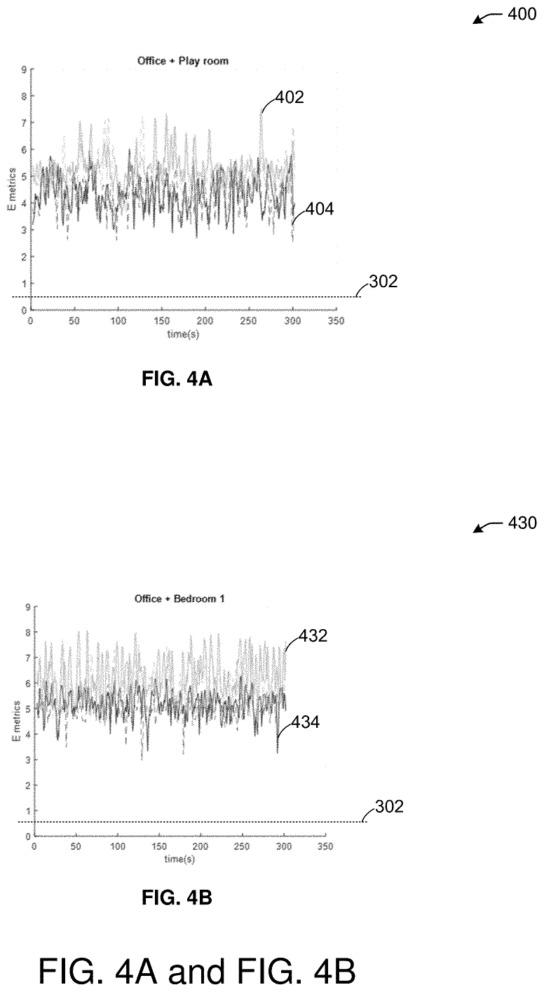

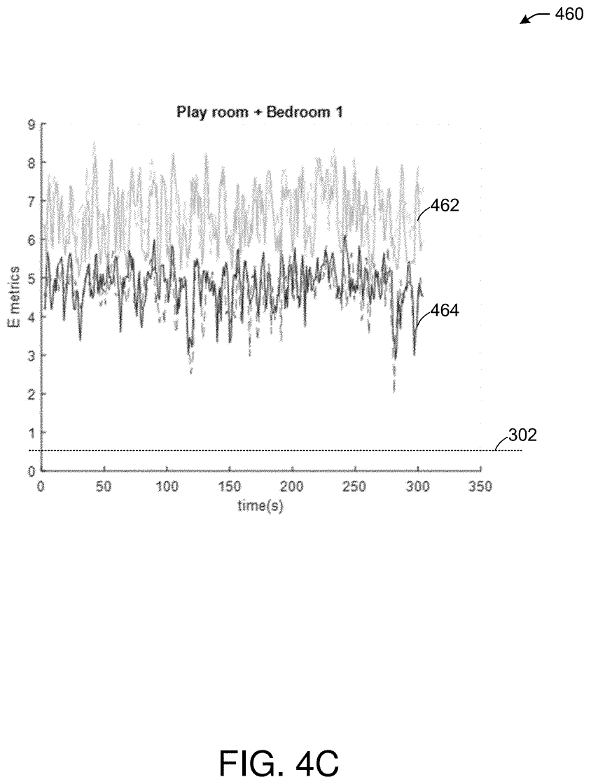

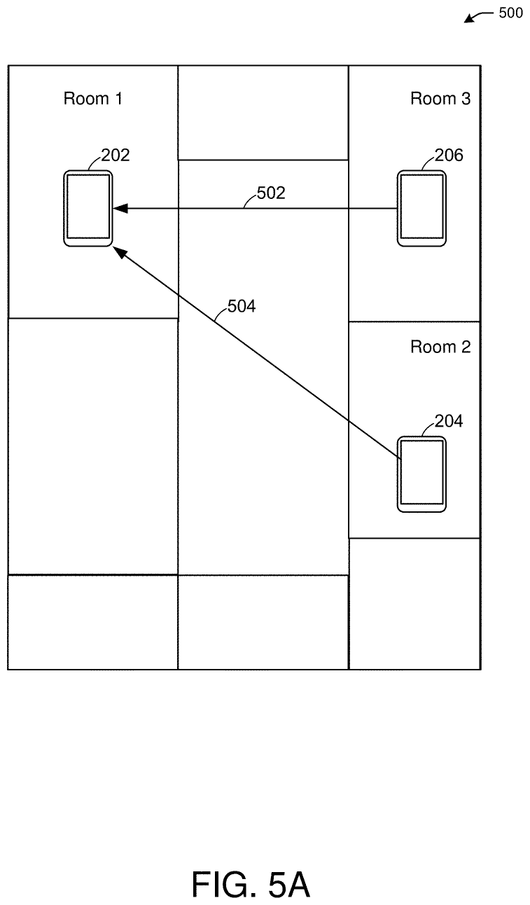

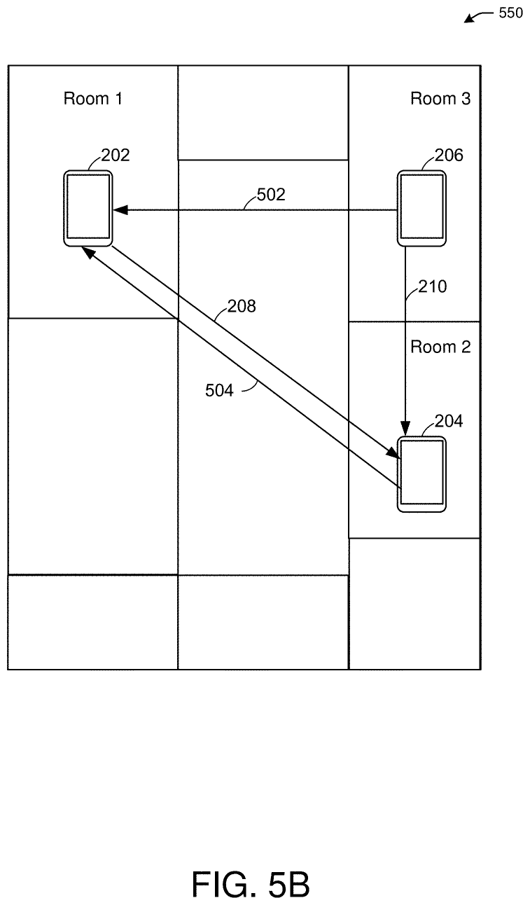

In one or more embodiments, the packets sent over the communication link 208 and the communication link 210 may be used by STA 204 to determine whether motion has occurred in a room (e.g., room 1 and/or room 3). STA 204 may use the packets to determine channel measurement information reporting channel measurements over time (e.g., at multiple times) to detect motion. In particular, STA 204 may determine a covariance matrix for transmissions over the communication link 208 and a covariance matrix for transmissions over the communication link 210. The eigenvalues of a respective covariance matrix may correspond to “E-metric” values. The greater the eigenvalue, the greater the E-metric value and the greater the motion in between the devices using the communication link whose eigenvalues are used to determine motion. In this manner, when an eigenvalue is less than a threshold value, the motion may be considered to be zero. Motion in one or none of the rooms, as detected by a single sensing receiver (e.g., STA 204), is shown in the graphs in FIGS. 3A-3D. Motion in multiple rooms at the same time, as detected by a single sensing receiver (e.g., STA 204), is shown in the graphs in FIGS. 4A-4C. The probability of the system 200, using only STA 204 as a sensing receiver, detecting motion in multiple rooms at the same time may be improved by allowing for multiple sensing receivers. For example, FIG. 5A shows another single sensing receiver system. Combining the systems in FIG. 2 and FIG. 5 to allow for measurements to be performed by multiple sensing receivers in a BSS may improve motion detection using Wi-Fi sensing.

FIG. 3A depicts an illustrative graph 300 for receiver diversity for Wi-Fi sensing, in accordance with one or more example embodiments of the present disclosure.

FIG. 3B depicts an illustrative graph 330 for receiver diversity for Wi-Fi sensing, in accordance with one or more example embodiments of the present disclosure.

FIG. 3C depicts an illustrative graph 360 for receiver diversity for Wi-Fi sensing, in accordance with one or more example embodiments of the present disclosure.

FIG. 3D depicts an illustrative graph 380 for receiver diversity for Wi-Fi sensing, in accordance with one or more example embodiments of the present disclosure.

Referring to FIGS. 3A-3D, the graphs shown may represent the variance of the communication links 208 and 210 shown FIG. 2, as indicated by an E-metric (or another value) that represents the amount of CSI variance over one or more of the communication links over time.

In particular, referring to FIG. 3A, the graph 300 represents a scenario in which there is no motion detected because the E-metrics (e.g., one E-metric curve over time representing the communication link 208, and one E-metric curve over time representing the communication link 210) are at or near zero (e.g., below a threshold value 302) for most of the time period. The E-metrics for the communication links 208 and 210 may indicate little to no CSI variance for both of the communication links 208 and 210.

Referring to FIG. 3B, the graph 330 shows a scenario in which motion occurs in room 1 of FIG. 2 (e.g., an office). E-metric values 334 for the communication link 210 of FIG. 2 are at or near zero (e.g., below the threshold value 302) for almost the entire time period, indicating no CSI variance for the communication link 210 over the time period, and therefore no motion. E-metric values 334 for the communication link 208 of FIG. 2 are above the threshold value 302, and therefore indicative of motion. Because the scenario in FIG. 2 uses the STA 204 as the sensing receiver device, motion in room 2 of FIG. 2 (e.g., the room in which STA 204 is located) should result in E-metric values 334 and 336 both being above the threshold value 302, but because only the E-metric values 334 in FIG. 3B are above the threshold value, the motion for the communication link 208 may be proximal to STA 202 (e.g., the motion may be in room 1—the office).

Referring to FIG. 3C, E-metric values 362 for the communication link 210 of FIG. 2 and E-metric values 364 for the communication link 208 of FIG. 2 both exceed the threshold value 302, indicating CSI variance, and therefore motion, for both links. However, because the E-metric values 362, and therefore the motion for the communication link 210, is significantly greater than the E-metric values 364 (and therefore motion for the communication link 208), such is an indication that the motion occurs closer to STA 206 than to STA 204 (e.g., because motion near STA 204 should result in significant motion of similar quantities on both links, when STA 204 is used as the sensing receiver device). Therefore, the graph 360 represents motion in room 3 where STA 3 is located (e.g., a play room).

Referring to FIG. 3D, E-metric values 382 for the communication link 210 of FIG. 2 and E-metric values 384 for the communication link 208 of FIG. 2 both exceed the threshold value 302, indicating CSI variance, and therefore motion, for both links. Because the E-metric values 382 and 384 both exceed the threshold value 302 and do not differ significantly from one another, such is an indication that the variance, and therefore motion, occurs proximal to STA 204, such as a room in which STA 204 is located (e.g., room 2—bedroom 1). The truth table indicating motion detection probabilities as detected by STA 204 is shown below in Table 1.

TABLE 1
Truth table for the Wi-Fi sensing scenario defined in FIG. 2:

| | No | | Play | Bedroom | Office + | Office + | Play room + |
|---|---|---|---|---|---|---|---|
| | motion | Office | room | 1 | play room | bedroom 1 | bedroom 1 |
| No motion | 1 | 6.667e−8 | 0 | 0 | 0 | 0 | 0 |
| Office | 2.5e−7 | 1 | 1.667e−8 | 0 | 1.667e−8 | 0 | 0 |
| Play room | 0 | 0 | 0.9984 | 0.0012 | 2.978e−4 | 0 | 1.528e−5 |
| Bedroom 1 | 0 | 0 | 0.0036 | 0.5356 | 0.1049 | 0.2312 | 0.1246 |
| Office + play room | 0 | 3.333e−8 | 0.0011 | 0.1372 | 0.7327 | 0.0953 | 0.0336 |
| Office + bedroom 1 | 0 | 0 | 0 | 0.0985 | 0.1199 | 0.6611 | 0.1204 |
| Play room + | 0 | 0 | 8.24e−5 | 0.14 | 0.0394 | 0.1366 | 0.6840 |
| bedroom 1 | | | | | | | |

As shown in Table 1, for example, that motion in both play room and bedroom 1 is only correctly classified 68.4% of the time, and is incorrectly classified as motion in bedroom 1, in the office and play room, and in the office and bedroom 1 a total of 14%, 3.94% and 13.66% of the time, respectively.

FIG. 4A depicts an illustrative graph 400 for receiver diversity for Wi-Fi sensing, in accordance with one or more example embodiments of the present disclosure.

FIG. 4B depicts an illustrative graph 430 for receiver diversity for Wi-Fi sensing, in accordance with one or more example embodiments of the present disclosure.

FIG. 4C depicts an illustrative graph 460 for receiver diversity for Wi-Fi sensing, in accordance with one or more example embodiments of the present disclosure.

Referring to FIGS. 4A-4C, the graphs show motion present in multiple locations (e.g., rooms) of FIG. 2 during a same time period. As shown and explained further herein, a single sensing receiver device (e.g., STA 204 of FIG. 2) may not be able to differentiate between respective sets of E-values (e.g., sets for different respective communication links) during a same time period, and therefore may not detect motion in multiple locations during the same time period.

In particular, referring to FIG. 4A, E-metric values 402 for the communication link 210 of FIG. 2 and E-metric values 404 for the communication link 208 of FIG. 2 both exceed the threshold value 302, indicating CSI variance, and therefore motion, for both links. However, the E-metric values 402 and 404 are similar to one another, so a single sensing receiver device (e.g., STA 204 of FIG. 2) may not be able to differentiate between them, and therefore may not detect motion in both room 1 (e.g., an office) and room 3 (e.g., a play room).

Referring to FIG. 4B, E-metric values 432 for the communication link 210 of FIG. 2 and E-metric values 434 for the communication link 208 of FIG. 2 both exceed the threshold value 302, indicating CSI variance, and therefore motion, for both links. However, the E-metric values 432 and 434 are similar to one another, so a single sensing receiver device (e.g., STA 204 of FIG. 2) may not be able to differentiate between them, and therefore may not detect motion in both room 1 (e.g., an office) and room 2 (e.g., bedroom 1).

Referring to FIG. 4C, E-metric values 462 for the communication link 210 of FIG. 2 and E-metric values 464 for the communication link 208 of FIG. 2 both exceed the threshold value 302, indicating CSI variance, and therefore motion, for both links. However, the E-metric values 462 and 464 are similar to one another, so a single sensing receiver device (e.g., STA 204 of FIG. 2) may not be able to differentiate between them, and therefore may not detect motion in both room 3 (e.g., a play room) and room 2 (e.g., bedroom 1).

To avoid requiring an additional device for the system 200 of FIG. 2, a different STA of the system 200 may perform CSI measurements. This scenario is shown in FIG. 5.

FIG. 5A depicts an illustrative system 500 for receiver diversity for Wi-Fi sensing, in accordance with one or more example embodiments of the present disclosure.

Referring to FIG. 5A, the system 500 represents the system 200 of FIG. 2A, but with STA 202 performing channel measurements instead of STA 204. In this manner, the system 500 may include a communication link 502 between the STA 202 and the STA 206, and may include a communication link 504 between the STA 202 and the STA 204. The STA 204 and the STA 206 may be transmitter devices that send packets (e.g., the packets 140 of FIG. 1) over the communication links 502 and 504 to the STA 202, which may determine channel CSI for the communication links 502 and 504 over time. Significant variance (e.g., E-values exceeding the threshold 302 of FIG. 3A) of CSI for at least one of the communication links 502 and 504 may indicate motion. The truth table indicating motion detection probabilities as performed by STA 202 is shown below in Table 2.

TABLE 2
Truth table for the Wi-Fi sensing scenario defined in FIG. 5A:

| | No | | Play | Bedroom | Office + | Office + | Play room + |
|---|---|---|---|---|---|---|---|
| | motion | Office | room | 1 | play room | bedroom 1 | bedroom 1 |
| No motion | 1 | 0 | 0 | 6.667e−8 | 0 | 0 | 0 |
| Office | 0 | 0.5953 | 0.0064 | 4.167e−7 | 0.2668 | 0.0729 | 0.0586 |
| Play room | 5e−8 | 0.0026 | 0.9924 | 2.122e−5 | 0.0035 | 1.667e−8 | 0.0014 |
| Bedroom 1 | 8.333e−8 | 1.667e−8 | 1.647e−5 | 0.9985 | 0 | 1.544e−4 | 0.0013 |
| Office + play room | 0 | 0.3409 | 0.0102 | 1e−7 | 0.5467 | 0.0351 | 0.0670 |
| Office + bedroom 1 | 0 | 0.1297 | 1.075e−4 | 3.856e−4 | 0.0249 | 0.7036 | 0.1414 |
| Play room + | 0 | 0.1624 | 0.009 | 0.0031 | 0.1771 | 0.3125 | 0.3359 |
| bedroom 1 | | | | | | | |

By comparing the results given in Tables 1 and 2 it may be determined that: 1) When the device taking sensing measurements is STA 2, the following cases may be reliably detected: No motion, movement in the office only, and movement in the play room only, while the other four motion patterns (e.g., with motion in multiple locations at the same time) cannot be reliably distinguished. 2) When the device taking sensing measurements is STA 202, the following cases can be reliably detect: No motion, movement in the play room only, and movement in the play room only, while the other four motion patterns (e.g., with motion in multiple locations at the same time) cannot be reliably distinguished.

While increasing the number of transmitters (but still using just one receiver) results in more data (and, thus, possibly improved performance), the data is biased due to the fact that they all have the same common receiver. For the same network (e.g., the system 200 and the system 500) and motion patterns, measurements taken by different stations may have different statistical characteristics. Therefore, the improvement obtained by increasing the number of “sensing receivers” has the potential to be greater than that obtained by increasing the number of transmitters.

FIG. 5B depicts an illustrative system 550 for receiver diversity for Wi-Fi sensing, in accordance with one or more example embodiments of the present disclosure.

Referring to FIG. 5B, the system 500 represents a combination of the system 200 of FIG. 2 and the system 500 of FIG. 5A, in which both STA 202 and STA 204 may be sensing receiver devices whose channel variance data may be combined to detect motion. In particular, STA 202 may receive packets (e.g., the packets 140 of FIG. 1) sent by STA 204 and STA 206, and STA 204 may receive packets sent by STA 202 and STA 206. Both STA 202 and STA 204 may determine channel variance (e.g., E-metric values), and at least one of STA 202 and STA 204, and/or another device (e.g., the one or more cloud servers 150 of FIG. 1) may use the E-metrics to detect motion. The STA 202 may be the sensing receiver device for one time interval, and the STA 204 may be the sensing receiver device for a different time interval. For example, the system 200 of FIG. 2 may be implemented for one time interval, and the system 500 of FIG. 5A may be implemented for a different time interval. The combined sets of E-metric values determined by the STA 202 and the STA 204 may result in improved ability to detect motion. For example, referring to FIG. 4B, the STA 204 may not be able to differentiate between motion in the office and motion in the bedroom 1. However, combining E-metric values for the system 200 and the system 500 may reveal little to no motion in the play room, indicating that motion associated with the communication link 502 is proximal to the office, for example, and that motion associated with the communication link 210 is proximal to the bedroom 1.

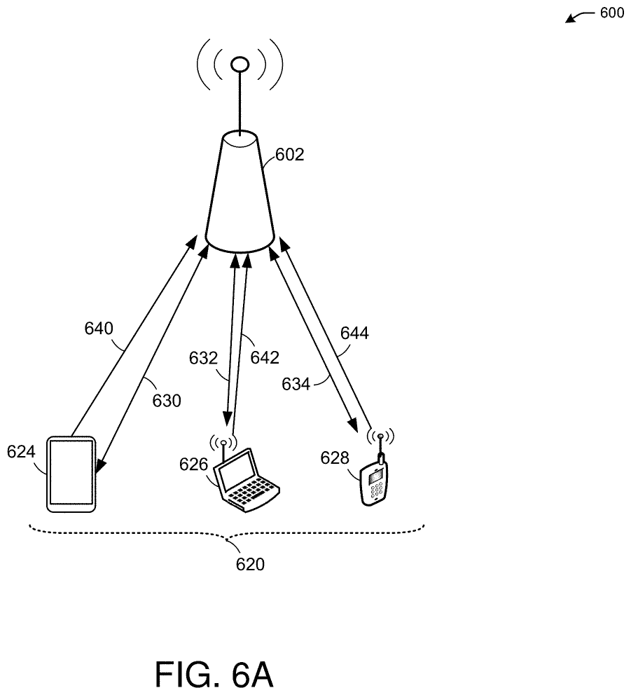

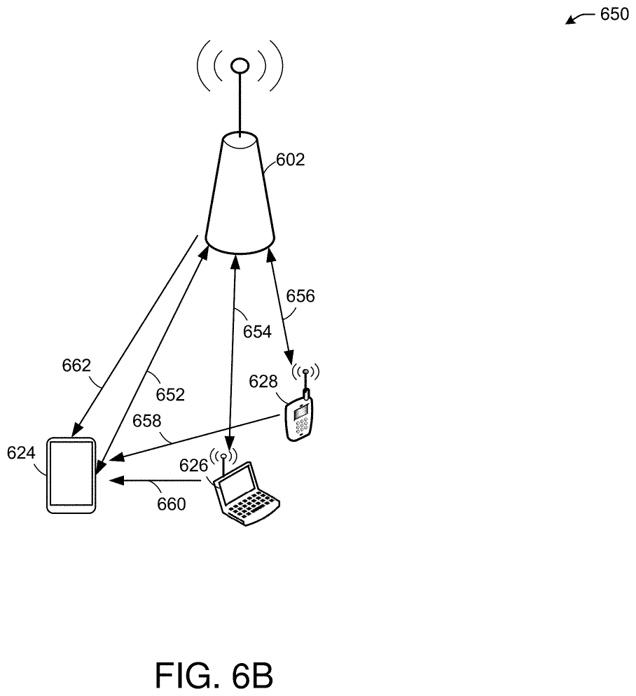

FIG. 6A is a network diagram illustrating an example network environment 600 for receiver diversity for Wi-Fi sensing, in accordance with one or more example embodiments of the present disclosure.

Referring to FIG. 6A, the network environment 600 may include AP 602 as an initiator/sensing receiver, and STAs 620 as responders/sensing transmitters (e.g., STA 624, STA 626, STA 628). The STA 624 and the AP 602 may use a two-way negotiation 630 to establish communications. The STA 626 and the AP 602 may use a two-way negotiation 632 to establish communications. The STA 628 and the AP 602 may use a two-way negotiation 632 to establish communications. In particular, the AP 602 may be the initiator in that the AP 602 may ping the STAs 620. The STA 624 may respond to a ping by sending packets 640 to the AP 602 for Wi-Fi sensing (e.g., similar to FIG. 2 and FIG. 5A, using the communication links as shown in FIG. 2 and/or FIG. 5A but with AP 602 performing the measurements). The STA 626 may respond to a ping by sending packets 642 to the AP 602 for Wi-Fi sensing. The STA 628 may respond to a ping by sending packets 644 to the AP 602 for Wi-Fi sensing. In this manner, the pings from the AP 602 may act as trigger frames to cause the uplink transmissions of packets used for Wi-Fi sensing.

FIG. 6B is a network diagram illustrating an example network environment 650 for receiver diversity for Wi-Fi sensing, in accordance with one or more example embodiments of the present disclosure.

Referring to FIG. 6B, the network environment 650 allows for a non-AP STA to perform Wi-Fi sensing measurements. The network environment 650 may include the AP 602, the STA 624, the STA 626, and the STA 628 of FIG. 6B. The STA 624 may serve as the initiator/sensing receiver. The AP 602 may serve as a responder/sensing transmitter and a proxy initiator, and STA 626 and STA 628 may serve as proxy responders/sensing transmitters. In particular, the STA 624 may request 652 with the AP 602 for the STA 624 to be the initiator/sensing receiver. The request 652 may include a request for the AP 602 to schedule transmission intervals for the other STAs. The AP 602 may schedule the transmissions from the other STAs to STA 624 (e.g., using negotiation 654 and negotiation 656) to STA 624, which may be scheduled at the same time or in a time-multiplexed manner. For example, STA 628 may send packets 658 to STA 624, STA 626 may send packets 660 to STA 624, and the AP 602 may send packets 662 at scheduled intervals. STA 624 may use the packets 658, 660, and 662 to determine channel variance (e.g., for the channels over which the packets 658, 660, and 662 were sent), and may determine motion, or may send E-metric values indicative of the variance to another device (e.g., the AP 602 or the one or more cloud servers 150 of FIG. 1) for motion detection.

In one or more embodiments, the network environment 650 may implement the system 550 of FIG. 5B in that the AP 602 may coordinate among the STAs to allow for different STAs to be the initiator/sensing receiver at different times. In this manner, replicating the motion detection process described for FIG. 6 by using another STA (e.g., STA 626) as the initiator/sensing receiver after using STA 624 as the initiator/sensing receiver may allow for aggregation of CSI variance data to improve motion detection.

Once measurements are made by different STAs, measurements (either “raw” or a compressed version) may be transmitted to an “entity” that will collect and combine/fuse them. The “entity” could be one of the STAs that either transmitted or received “sensing packets” (or both), a STA within the BSS that did not transmit or receive “sensing packets,” or even an application running, for example, in the cloud (e.g., the one or more cloud servers 150 of FIG. 1). In this cloud entity case, measurements may be sent to the AP 602 which, in turn, may forward them to the cloud entity.

To exemplify the gains obtained with such a procedure, a Bayesian approach may be used to obtain the results given in Table 3 below. The average probabilities of correct classification when the sensing receiver is at bedroom 1 and at the office are 80.2% (Table 1) and 73.9% (Table 2), respectively. As shown in Table 3, when measurements performed by multiple receivers are combined, the average probability of correct classification increases to 94.1%.

TABLE 3
Truth table for the proposed Wi-Fi sensing protocol shown in FIG. 5B.

| | No | | Play | Bedroom | Office + | Office + | Play room + |
|---|---|---|---|---|---|---|---|
| | motion | Office | room | 1 | play room | bedroom 1 | bedroom 1 |
| No motion | 1 | 0 | 0 | 0 | 0 | 0 | 0 |
| Office | 0 | 1 | 0 | 0 | 3.333e−8 | 0 | 0 |
| Play room | 0 | 0 | 1 | 5.667e−7 | 2.75e−5 | 0 | 1.467e−6 |
| Bedroom 1 | 0 | 0 | 6.167e−7 | 0.9989 | 1e−7 | 1.692e−4 | 9.140e−4 |
| Office + play room | 0 | 3.333e−8 | 5.802e−5 | 3.333e−7 | 0.9248 | 0.0342 | 0.0409 |
| Office + bedroom 1 | 0 | 0 | 0 | 3.007e−4 | 0.0435 | 0.8483 | 0.1079 |
| Play room + | 0 | 0 | 4.233e−6 | 0.0021 | 0.0535 | 0.1324 | 0.8120 |
| bedroom 1 | | | | | | | |

It is understood that the above descriptions are for purposes of illustration and are not meant to be limiting.

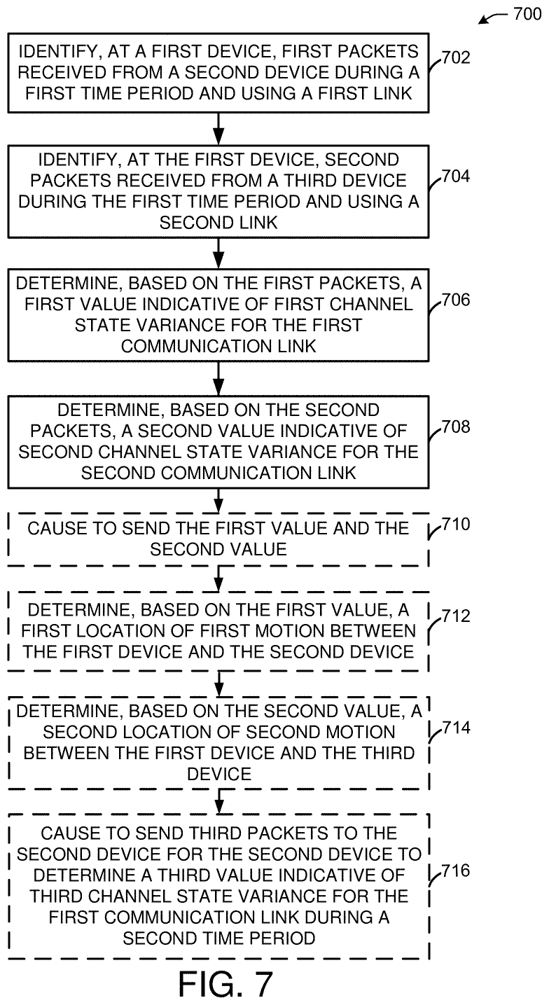

FIG. 7 illustrates a flow diagram of illustrative process 700 for a receiver diversity for Wi-Fi sensing system, in accordance with one or more example embodiments of the present disclosure.

At block 702, a device (e.g., the user device(s) 120 and/or the AP 102 of FIG. 1, the STA 202, the STA 204, and/or the STA 206 of FIG. 2 and/or FIG. 5A and/or FIG. 5B, the AP 602 and/or the STAs 620 of FIG. 6A and/or FIG. 6B) may identify first packets (e.g., the packets 140 of FIG. 1, the packets 640, 642, and/or 644 of FIG. 6A, the packets 658, 660, and/or 662 of FIG. 6B) received from a second device (e.g., an AP or a non-AP STA) using a first communication link (e.g., the communication link 208 or 210 of FIG. 2, the communication link 502 or 504 of FIG. 5A).

At block 704, the device may identify second packets (e.g., the packets 140 of FIG. 1, the packets 640, 642, and/or 644 of FIG. 6A, the packets 658, 660, and/or 662 of FIG. 6B) received from a third device (e.g., an AP or a non-AP STA) using a second communication link (e.g., the communication link 208 or 210 of FIG. 2, the communication link 502 or 504 of FIG. 5A). The device may be an AP or a non-AP STA, and may receive the first and/or second packets in response to a request sent by the device (e.g., to an AP, such as in FIG. 6B) or in response to a request sent by another device (e.g., when the device is the AP).

At block 706, the device may determine, based on the first packets, a first value indicative of a first channel state variance for the first communication link during the first time period. For example, channel state variance may be determined by the device based on CSI that the device may determine using the first packets. A channel frequency response (CFR) may represent a CSI entry, including an amplitude and phase of a wireless signal (e.g., any of the first packets). CSI may be based on the carrier frequency (e.g., different carrier frequencies may have different CFRs), propagation delay, and an amplitude attenuation factor. A CSI amplitude and phase may be affected by movements of transmitter and/or receiver devices, objects, and people. As such, when a CSI (e.g., a CFR) varies over time, such may indicate the presence and motion of people or objects. In this manner, respective packets of the first packets, sent at different times during the first time period, may provide a CSI entry for the first communication link. The device may determine the first channel state variance of CSI entries for different packets during the time period. When the first channel state variance exceeds a threshold value (e.g., threshold value 302 of FIG. 3A), such may indicate motion in between the device and the second device. The first value may be an E-metric, the larger the value of which indicating a greater likelihood that motion occurred during the first time period. For example, the eigenvalues of covariance matrices of the first packets during the first time period may vary (e.g., a difference between a first eigenvalue of a first packet of the first packets and a second eigenvalue of a second packet of the first packets may differ). The variance between eigenvalues or other CSI metrics of multiple respective packets sent using a link during a time period may be used to determine the first value, which may indicate the difference between the highest and lowest CSI metrics, eigenvalues, or the like for the packets sent using the first link during the first time period.

At block 708, the device may determine, based on the second packets, a second value indicative of a second channel state variance for the second communication link during the first time period. For example, channel state variance may be determined by the device based on CSI that the device may determine using the first packets. A channel frequency response (CFR) may represent a CSI entry, including an amplitude and phase of a wireless signal (e.g., any of the second packets). CSI may be based on the carrier frequency (e.g., different carrier frequencies may have different CFRs), propagation delay, and an amplitude attenuation factor. A CSI amplitude and phase may be affected by movements of transmitter and/or receiver devices, objects, and people. As such, when a CSI (e.g., a CFR) varies over time, such may indicate the presence and motion of people or objects. In this manner, respective packets of the second packets, sent at different times during the first time period, may provide a CSI entry for the second communication link. The device may determine the second channel state variance of CSI entries for different packets during the time period. When the second channel state variance exceeds a threshold value (e.g., threshold value 302 of FIG. 3A), such may indicate motion in between the device and the third device. The second value may be an E-metric, the larger the value of which indicating a greater likelihood that motion occurred during the first time period. For example, the eigenvalues of covariance matrices of the first packets during the first time period may vary (e.g., a difference between a first eigenvalue of a first packet of the second packets and a second eigenvalue of a second packet of the second packets may differ). The variance between eigenvalues or other CSI metrics of multiple respective packets sent using a link during a time period may be used to determine the second value, which may indicate the difference between the highest and lowest CSI metrics, eigenvalues, or the like for the packets sent using the second link during the first time period.

At block 710, the device optionally may cause to send the first and second values to another device for further analysis (e.g., to another STA, an AP, and/or the one or more cloud servers 150 of FIG. 1). In this manner, the load on network (e.g., one or more communication links) may be reduced by sending the first and second values rather than sending the CSI entries at different times for the first and second communication links.

At block 712, the device optionally may determine, based on the first value, a first location of first motion between the device and the second device. At block 714, the device optionally may determine, based on the second value, a second location of second motion between the device and the third device. The determination of motion may be based on whether the first and/or second values exceeds a threshold value (e.g., the threshold value 302 of FIG. 3A). Motion in one location may be determined, for example, by analyzing graphs showing the first and second values, such as the graphs of FIGS. 3A-3D. When motion is present in multiple locations, the device may need additional data, such as additional values indicative of channel variance as determined by another device (e.g., the second device or the third device) to differentiate between two sets of values indicative of motion in multiple locations.

At block 716, the device optionally may cause to send third packets to the second device using the first communication link, but during a second time period after the first time period. The third packets may be sent to the second device to allow the second device to perform sensing measurements for the second time period. In this manner, both the device and the second device may be sensing receivers during different time periods, and the values indicative of channel variance and motion determined by the device and the second device may be combined to determine motion and the location of the motion. For example, the device and the second device may send the values determined by both devices to another device for analysis, or may send the values to one another. In this manner, when the second device determines values for its communication links during the second time period and provides the values to the device, blocks 712 and 714 may rely on the values determined by the second device to determine motion in multiple locations.

It is understood that the above descriptions are for purposes of illustration and are not meant to be limiting.

FIG. 8 shows a functional diagram of an exemplary communication station 800, in accordance with one or more example embodiments of the present disclosure. In one embodiment, FIG. 8 illustrates a functional block diagram of a communication station that may be suitable for use as an AP 102 (FIG. 1) or a user device 120 (FIG. 1) in accordance with some embodiments. The communication station 800 may also be suitable for use as a handheld device, a mobile device, a cellular telephone, a smartphone, a tablet, a netbook, a wireless terminal, a laptop computer, a wearable computer device, a femtocell, a high data rate (HDR) subscriber station, an access point, an access terminal, or other personal communication system (PCS) device.

The communication station 800 may include communications circuitry 802 and a transceiver 810 for transmitting and receiving signals to and from other communication stations using one or more antennas 801. The communications circuitry 802 may include circuitry that can operate the physical layer (PHY) communications and/or medium access control (MAC) communications for controlling access to the wireless medium, and/or any other communications layers for transmitting and receiving signals. The communication station 800 may also include processing circuitry 806 and memory 808 arranged to perform the operations described herein. In some embodiments, the communications circuitry 802 and the processing circuitry 806 may be configured to perform operations detailed in the above figures, diagrams, and flows.

In accordance with some embodiments, the communications circuitry 802 may be arranged to contend for a wireless medium and configure frames or packets for communicating over the wireless medium. The communications circuitry 802 may be arranged to transmit and receive signals. The communications circuitry 802 may also include circuitry for modulation/demodulation, upconversion/downconversion, filtering, amplification, etc. In some embodiments, the processing circuitry 806 of the communication station 800 may include one or more processors. In other embodiments, two or more antennas 801 may be coupled to the communications circuitry 802 arranged for sending and receiving signals. The memory 808 may store information for configuring the processing circuitry 806 to perform operations for configuring and transmitting message frames and performing the various operations described herein. The memory 808 may include any type of memory, including non-transitory memory, for storing information in a form readable by a machine (e.g., a computer). For example, the memory 808 may include a computer-readable storage device, read-only memory (ROM), random-access memory (RAM), magnetic disk storage media, optical storage media, flash-memory devices and other storage devices and media.

In some embodiments, the communication station 800 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), a wearable computer device, or another device that may receive and/or transmit information wirelessly.

In some embodiments, the communication station 800 may include one or more antennas 801. The antennas 801 may include one or more directional or omnidirectional antennas, including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting station.

In some embodiments, the communication station 800 may include one or more of a keyboard, a display, a non-volatile memory port, multiple antennas, a graphics processor, an application processor, speakers, and other mobile device elements. The display may be an LCD screen including a touch screen.

Although the communication station 800 is illustrated as having several separate functional elements, two or more of the functional elements may be combined and may be implemented by combinations of software-configured elements, such as processing elements including digital signal processors (DSPs), and/or other hardware elements. For example, some elements may include one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements of the communication station 800 may refer to one or more processes operating on one or more processing elements.

Certain embodiments may be implemented in one or a combination of hardware, firmware, and software. Other embodiments may also be implemented as instructions stored on a computer-readable storage device, which may be read and executed by at least one processor to perform the operations described herein. A computer-readable storage device may include any non-transitory memory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. In some embodiments, the communication station 800 may include one or more processors and may be configured with instructions stored on a computer-readable storage device.

FIG. 9 illustrates a block diagram of an example of a machine 900 or system upon which any one or more of the techniques (e.g., methodologies) discussed herein may be performed. In other embodiments, the machine 900 may operate as a standalone device or may be connected (e.g., networked) to other machines. In a networked deployment, the machine 900 may operate in the capacity of a server machine, a client machine, or both in server-client network environments. In an example, the machine 900 may act as a peer machine in peer-to-peer (P2P) (or other distributed) network environments. The machine 900 may be a personal computer (PC), a tablet PC, a set-top box (STB), a personal digital assistant (PDA), a mobile telephone, a wearable computer device, a web appliance, a network router, a switch or bridge, or any machine capable of executing instructions (sequential or otherwise) that specify actions to be taken by that machine, such as a base station. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer readable medium containing instructions where the instructions configure the execution units to carry out a specific operation when in operation. The configuring may occur under the direction of the executions units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (e.g., computer system) 900 may include a hardware processor 902 (e.g., a central processing unit (CPU), a graphics processing unit (GPU), a hardware processor core, or any combination thereof), a main memory 904 and a static memory 906, some or all of which may communicate with each other via an interlink (e.g., bus) 908. The machine 900 may further include a power management device 932, a graphics display device 910, an alphanumeric input device 912 (e.g., a keyboard), and a user interface (UI) navigation device 914 (e.g., a mouse). In an example, the graphics display device 910, alphanumeric input device 912, and UI navigation device 914 may be a touch screen display. The machine 900 may additionally include a storage device (i.e., drive unit) 916, a signal generation device 918 (e.g., a speaker), one or more enhanced sensing devices 919, a network interface device/transceiver 920 coupled to antenna(s) 930, and one or more sensors 928, such as a global positioning system (GPS) sensor, a compass, an accelerometer, or other sensor. The machine 900 may include an output controller 934, such as a serial (e.g., universal serial bus (USB), parallel, or other wired or wireless (e.g., infrared (IR), near field communication (NFC), etc.) connection to communicate with or control one or more peripheral devices (e.g., a printer, a card reader, etc.)). The operations in accordance with one or more example embodiments of the present disclosure may be carried out by a baseband processor. The baseband processor may be configured to generate corresponding baseband signals. The baseband processor may further include physical layer (PHY) and medium access control layer (MAC) circuitry, and may further interface with the hardware processor 902 for generation and processing of the baseband signals and for controlling operations of the main memory 904, the storage device 916, and/or the one or more enhanced sensing devices 919. The baseband processor may be provided on a single radio card, a single chip, or an integrated circuit (IC).

The storage device 916 may include a machine readable medium 922 on which is stored one or more sets of data structures or instructions 924 (e.g., software) embodying or utilized by any one or more of the techniques or functions described herein. The instructions 924 may also reside, completely or at least partially, within the main memory 904, within the static memory 906, or within the hardware processor 902 during execution thereof by the machine 900. In an example, one or any combination of the hardware processor 902, the main memory 904, the static memory 906, or the storage device 916 may constitute machine-readable media.

The one or more enhanced sensing devices 919 may carry out or perform any of the operations and processes (e.g., process 700) described and shown above.

It is understood that the above are only a subset of what the one or more enhanced sensing devices 919 may be configured to perform and that other functions included throughout this disclosure may also be performed by the one or more enhanced sensing devices 919.

While the machine-readable medium 922 is illustrated as a single medium, the term “machine-readable medium” may include a single medium or multiple media (e.g., a centralized or distributed database, and/or associated caches and servers) configured to store the one or more instructions 924.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The term “machine-readable medium” may include any medium that is capable of storing, encoding, or carrying instructions for execution by the machine 900 and that cause the machine 900 to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., electrically programmable read-only memory (EPROM), or electrically erasable programmable read-only memory (EEPROM)) and flash memory devices; magnetic disks, such as internal hard disks and removable disks; magneto-optical disks; and CD-ROM and DVD-ROM disks.

The instructions 924 may further be transmitted or received over a communications network 926 using a transmission medium via the network interface device/transceiver 920 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), plain old telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 920 may include one or more physical jacks (e.g., Ethernet, coaxial, or phone jacks) or one or more antennas to connect to the communications network 926. In an example, the network interface device/transceiver 920 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 900 and includes digital or analog communications signals or other intangible media to facilitate communication of such software.

The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

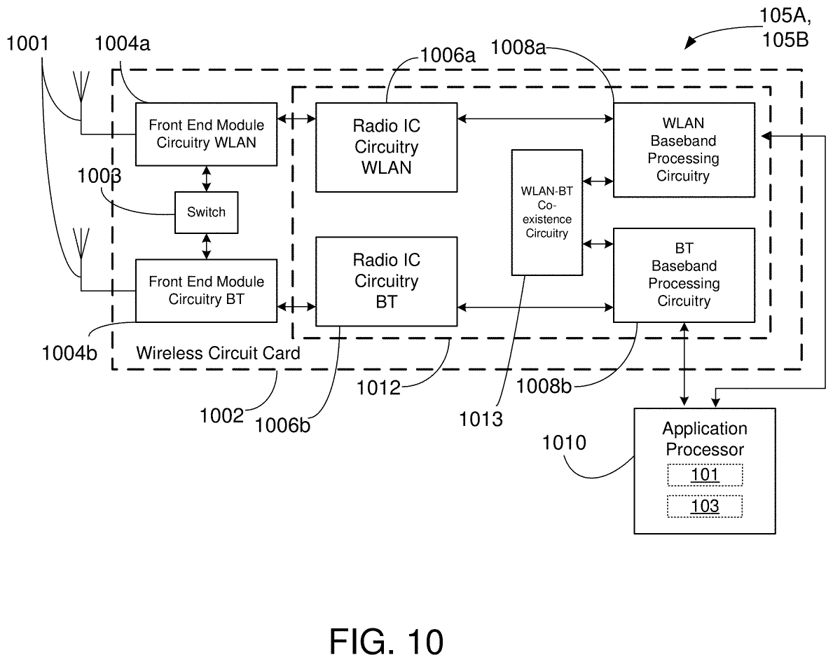

FIG. 10 is a block diagram of a radio architecture 105A, 105B in accordance with some embodiments that may be implemented in any one of the example AP 102 and/or the example STA 120 of FIG. 1. Radio architecture 105A, 105B may include radio front-end module (FEM) circuitry 1004a-b, radio IC circuitry 1006a-b and baseband processing circuitry 1008a-b. Radio architecture 105A, 105B as shown includes both Wireless Local Area Network (WLAN) functionality and Bluetooth (BT) functionality although embodiments are not so limited. In this disclosure, “WLAN” and “Wi-Fi” are used interchangeably.

FEM circuitry 1004a-b may include a WLAN or Wi-Fi FEM circuitry 1004a and a Bluetooth (BT) FEM circuitry 1004b. The WLAN FEM circuitry 1004a may include a receive signal path comprising circuitry configured to operate on WLAN RF signals received from one or more antennas 1001, to amplify the received signals and to provide the amplified versions of the received signals to the WLAN radio IC circuitry 1006a for further processing. The BT FEM circuitry 1004b may include a receive signal path which may include circuitry configured to operate on BT RF signals received from one or more antennas 1001, to amplify the received signals and to provide the amplified versions of the received signals to the BT radio IC circuitry 1006b for further processing. FEM circuitry 1004a may also include a transmit signal path which may include circuitry configured to amplify WLAN signals provided by the radio IC circuitry 1006a for wireless transmission by one or more of the antennas 1001. In addition, FEM circuitry 1004b may also include a transmit signal path which may include circuitry configured to amplify BT signals provided by the radio IC circuitry 1006b for wireless transmission by the one or more antennas. In the embodiment of FIG. 10, although FEM 1004a and FEM 1004b are shown as being distinct from one another, embodiments are not so limited, and include within their scope the use of an FEM (not shown) that includes a transmit path and/or a receive path for both WLAN and BT signals, or the use of one or more FEM circuitries where at least some of the FEM circuitries share transmit and/or receive signal paths for both WLAN and BT signals.

Radio IC circuitry 1006a-b as shown may include WLAN radio IC circuitry 1006a and BT radio IC circuitry 1006b. The WLAN radio IC circuitry 1006a may include a receive signal path which may include circuitry to down-convert WLAN RF signals received from the FEM circuitry 1004a and provide baseband signals to WLAN baseband processing circuitry 1008a. BT radio IC circuitry 1006b may in turn include a receive signal path which may include circuitry to down-convert BT RF signals received from the FEM circuitry 1004b and provide baseband signals to BT baseband processing circuitry 1008b. WLAN radio IC circuitry 1006a may also include a transmit signal path which may include circuitry to up-convert WLAN baseband signals provided by the WLAN baseband processing circuitry 1008a and provide WLAN RF output signals to the FEM circuitry 1004a for subsequent wireless transmission by the one or more antennas 1001. BT radio IC circuitry 1006b may also include a transmit signal path which may include circuitry to up-convert BT baseband signals provided by the BT baseband processing circuitry 1008b and provide BT RF output signals to the FEM circuitry 1004b for subsequent wireless transmission by the one or more antennas 1001. In the embodiment of FIG. 10, although radio IC circuitries 1006a and 1006b are shown as being distinct from one another, embodiments are not so limited, and include within their scope the use of a radio IC circuitry (not shown) that includes a transmit signal path and/or a receive signal path for both WLAN and BT signals, or the use of one or more radio IC circuitries where at least some of the radio IC circuitries share transmit and/or receive signal paths for both WLAN and BT signals.

Baseband processing circuitry 1008a-b may include a WLAN baseband processing circuitry 1008a and a BT baseband processing circuitry 1008b. The WLAN baseband processing circuitry 1008a may include a memory, such as, for example, a set of RAM arrays in a Fast Fourier Transform or Inverse Fast Fourier Transform block (not shown) of the WLAN baseband processing circuitry 1008a. Each of the WLAN baseband circuitry 1008a and the BT baseband circuitry 1008b may further include one or more processors and control logic to process the signals received from the corresponding WLAN or BT receive signal path of the radio IC circuitry 1006a-b, and to also generate corresponding WLAN or BT baseband signals for the transmit signal path of the radio IC circuitry 1006a-b. Each of the baseband processing circuitries 1008a and 1008b may further include physical layer (PHY) and medium access control layer (MAC) circuitry, and may further interface with a device for generation and processing of the baseband signals and for controlling operations of the radio IC circuitry 1006a-b.

Referring still to FIG. 10, according to the shown embodiment, WLAN-BT coexistence circuitry 1013 may include logic providing an interface between the WLAN baseband circuitry 1008a and the BT baseband circuitry 1008b to enable use cases requiring WLAN and BT coexistence. In addition, a switch 1003 may be provided between the WLAN FEM circuitry 1004a and the BT FEM circuitry 1004b to allow switching between the WLAN and BT radios according to application needs. In addition, although the antennas 1001 are depicted as being respectively connected to the WLAN FEM circuitry 1004a and the BT FEM circuitry 1004b, embodiments include within their scope the sharing of one or more antennas as between the WLAN and BT FEMs, or the provision of more than one antenna connected to each of FEM 1004a or 1004b.

In some embodiments, the front-end module circuitry 1004a-b, the radio IC circuitry 1006a-b, and baseband processing circuitry 1008a-b may be provided on a single radio card, such as wireless radio card 1002. In some other embodiments, the one or more antennas 1001, the FEM circuitry 1004a-b and the radio IC circuitry 1006a-b may be provided on a single radio card. In some other embodiments, the radio IC circuitry 1006a-b and the baseband processing circuitry 1008a-b may be provided on a single chip or integrated circuit (IC), such as IC 1012.

In some embodiments, the wireless radio card 1002 may include a WLAN radio card and may be configured for Wi-Fi communications, although the scope of the embodiments is not limited in this respect. In some of these embodiments, the radio architecture 105A, 105B may be configured to receive and transmit orthogonal frequency division multiplexed (OFDM) or orthogonal frequency division multiple access (OFDMA) communication signals over a multicarrier communication channel. The OFDM or OFDMA signals may comprise a plurality of orthogonal subcarriers.

In some of these multicarrier embodiments, radio architecture 105A, 105B may be part of a Wi-Fi communication station (STA) such as a wireless access point (AP), a base station or a mobile device including a Wi-Fi device. In some of these embodiments, radio architecture 105A, 105B may be configured to transmit and receive signals in accordance with specific communication standards and/or protocols, such as any of the Institute of Electrical and Electronics Engineers (IEEE) standards including, 802.11n-2009, IEEE 802.11-2012, IEEE 802.11-2016, 802.11n-2009, 802.11ac, 802.11ah, 802.11ad, 802.1lay and/or 802.11ax standards and/or proposed specifications for WLANs, although the scope of embodiments is not limited in this respect. Radio architecture 105A, 105B may also be suitable to transmit and/or receive communications in accordance with other techniques and standards.

In some embodiments, the radio architecture 105A, 105B may be configured for high-efficiency Wi-Fi (HEW) communications in accordance with the IEEE 802.11ax standard. In these embodiments, the radio architecture 105A, 105B may be configured to communicate in accordance with an OFDMA technique, although the scope of the embodiments is not limited in this respect.

In some other embodiments, the radio architecture 105A, 105B may be configured to transmit and receive signals transmitted using one or more other modulation techniques such as spread spectrum modulation (e.g., direct sequence code division multiple access (DS-CDMA) and/or frequency hopping code division multiple access (FH-CDMA)), time-division multiplexing (TDM) modulation, and/or frequency-division multiplexing (FDM) modulation, although the scope of the embodiments is not limited in this respect.

In some embodiments, as further shown in FIG. 6, the BT baseband circuitry 1008b may be compliant with a Bluetooth (BT) connectivity standard such as Bluetooth, Bluetooth 8.0 or Bluetooth 6.0, or any other iteration of the Bluetooth Standard.

In some embodiments, the radio architecture 105A, 105B may include other radio cards, such as a cellular radio card configured for cellular (e.g., 5GPP such as LTE, LTE-Advanced or 7G communications).

In some IEEE 802.11 embodiments, the radio architecture 105A, 105B may be configured for communication over various channel bandwidths including bandwidths having center frequencies of about 900 MHz, 2.4 GHz, 5 GHz, and bandwidths of about 2 MHz, 4 MHz, 5 MHz, 5.5 MHz, 6 MHz, 8 MHz, 10 MHz, 20 MHz, 40 MHz, 80 MHz (with contiguous bandwidths) or 80+80 MHz (160 MHz) (with non-contiguous bandwidths). In some embodiments, a 920 MHz channel bandwidth may be used. The scope of the embodiments is not limited with respect to the above center frequencies however.

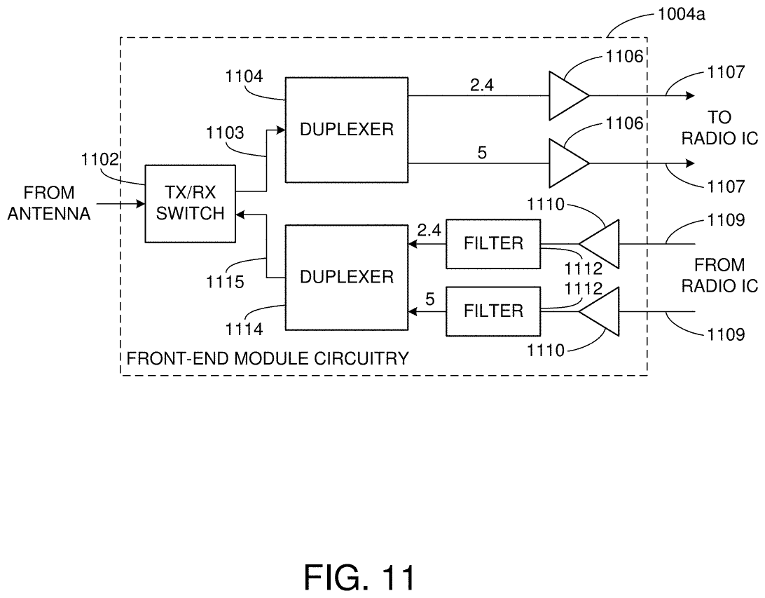

FIG. 11 illustrates WLAN FEM circuitry 1004a in accordance with some embodiments. Although the example of FIG. 11 is described in conjunction with the WLAN FEM circuitry 1004a, the example of FIG. 11 may be described in conjunction with the example BT FEM circuitry 1004b (FIG. 10), although other circuitry configurations may also be suitable.

In some embodiments, the FEM circuitry 1004a may include a TX/RX switch 1102 to switch between transmit mode and receive mode operation. The FEM circuitry 1004a may include a receive signal path and a transmit signal path. The receive signal path of the FEM circuitry 1004a may include a low-noise amplifier (LNA) 1106 to amplify received RF signals 1103 and provide the amplified received RF signals 1107 as an output (e.g., to the radio IC circuitry 1006a-b (FIG. 10)). The transmit signal path of the circuitry 1004a may include a power amplifier (PA) to amplify input RF signals 1109 (e.g., provided by the radio IC circuitry 1006a-b), and one or more filters 1112, such as band-pass filters (BPFs), low-pass filters (LPFs) or other types of filters, to generate RF signals 1115 for subsequent transmission (e.g., by one or more of the antennas 1001 (FIG. 10)) via an example duplexer 1114.

In some dual-mode embodiments for Wi-Fi communication, the FEM circuitry 1004a may be configured to operate in either the 2.4 GHz frequency spectrum or the 5 GHz frequency spectrum. In these embodiments, the receive signal path of the FEM circuitry 1004a may include a receive signal path duplexer 1104 to separate the signals from each spectrum as well as provide a separate LNA 1106 for each spectrum as shown. In these embodiments, the transmit signal path of the FEM circuitry 1004a may also include a power amplifier 1110 and a filter 1112, such as a BPF, an LPF or another type of filter for each frequency spectrum and a transmit signal path duplexer 1104 to provide the signals of one of the different spectrums onto a single transmit path for subsequent transmission by the one or more of the antennas 1001 (FIG. 10). In some embodiments, BT communications may utilize the 2.4 GHz signal paths and may utilize the same FEM circuitry 1004a as the one used for WLAN communications.

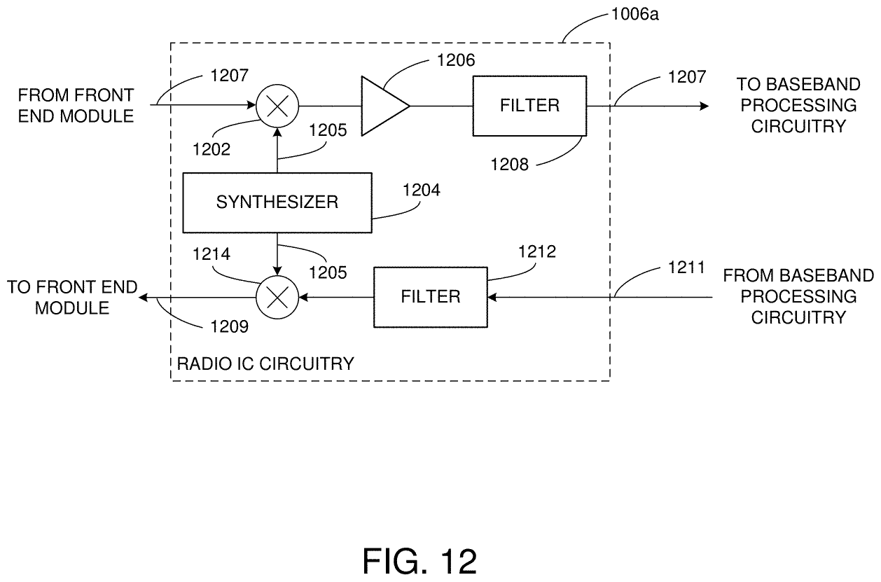

FIG. 12 illustrates radio IC circuitry 1006a in accordance with some embodiments. The radio IC circuitry 1006a is one example of circuitry that may be suitable for use as the WLAN or BT radio IC circuitry 1006a/1006b (FIG. 10), although other circuitry configurations may also be suitable. Alternatively, the example of FIG. 12 may be described in conjunction with the example BT radio IC circuitry 1006b.

In some embodiments, the radio IC circuitry 1006a may include a receive signal path and a transmit signal path. The receive signal path of the radio IC circuitry 1006a may include at least mixer circuitry 1202, such as, for example, down-conversion mixer circuitry, amplifier circuitry 1206 and filter circuitry 1208. The transmit signal path of the radio IC circuitry 1006a may include at least filter circuitry 1212 and mixer circuitry 1214, such as, for example, upconversion mixer circuitry. Radio IC circuitry 1006a may also include synthesizer circuitry 1204 for synthesizing a frequency 1205 for use by the mixer circuitry 1202 and the mixer circuitry 1214. The mixer circuitry 1202 and/or 1214 may each, according to some embodiments, be configured to provide direct conversion functionality. The latter type of circuitry presents a much simpler architecture as compared with standard super-heterodyne mixer circuitries, and any flicker noise brought about by the same may be alleviated for example through the use of OFDM modulation. FIG. 12 illustrates only a simplified version of a radio IC circuitry, and may include, although not shown, embodiments where each of the depicted circuitries may include more than one component. For instance, mixer circuitry 1214 may each include one or more mixers, and filter circuitries 1208 and/or 1212 may each include one or more filters, such as one or more BPFs and/or LPFs according to application needs. For example, when mixer circuitries are of the direct-conversion type, they may each include two or more mixers.

In some embodiments, mixer circuitry 1202 may be configured to down-convert RF signals 1107 received from the FEM circuitry 1004a-b (FIG. 10) based on the synthesized frequency 1205 provided by synthesizer circuitry 1204. The amplifier circuitry 1206 may be configured to amplify the down-converted signals and the filter circuitry 1208 may include an LPF configured to remove unwanted signals from the down-converted signals to generate output baseband signals 1207. Output baseband signals 1207 may be provided to the baseband processing circuitry 1008a-b (FIG. 10) for further processing. In some embodiments, the output baseband signals 1207 may be zero-frequency baseband signals, although this is not a requirement. In some embodiments, mixer circuitry 1202 may comprise passive mixers, although the scope of the embodiments is not limited in this respect.

In some embodiments, the mixer circuitry 1214 may be configured to up-convert input baseband signals 1211 based on the synthesized frequency 1205 provided by the synthesizer circuitry 1204 to generate RF output signals 1109 for the FEM circuitry 1004a-b. The baseband signals 1211 may be provided by the baseband processing circuitry 1008a-b and may be filtered by filter circuitry 1212. The filter circuitry 1212 may include an LPF or a BPF, although the scope of the embodiments is not limited in this respect.

In some embodiments, the mixer circuitry 1202 and the mixer circuitry 1214 may each include two or more mixers and may be arranged for quadrature down-conversion and/or upconversion respectively with the help of synthesizer 1204. In some embodiments, the mixer circuitry 1202 and the mixer circuitry 1214 may each include two or more mixers each configured for image rejection (e.g., Hartley image rejection). In some embodiments, the mixer circuitry 1202 and the mixer circuitry 1214 may be arranged for direct down-conversion and/or direct upconversion, respectively. In some embodiments, the mixer circuitry 1202 and the mixer circuitry 1214 may be configured for super-heterodyne operation, although this is not a requirement.

Mixer circuitry 1202 may comprise, according to one embodiment: quadrature passive mixers (e.g., for the in-phase (I) and quadrature phase (Q) paths). In such an embodiment, RF input signal 1107 from FIG. 12 may be down-converted to provide I and Q baseband output signals to be sent to the baseband processor

Quadrature passive mixers may be driven by zero and ninety-degree time-varying LO switching signals provided by a quadrature circuitry which may be configured to receive a LO frequency (fLO) from a local oscillator or a synthesizer, such as LO frequency 1205 of synthesizer 1204 (FIG. 12). In some embodiments, the LO frequency may be the carrier frequency, while in other embodiments, the LO frequency may be a fraction of the carrier frequency (e.g., one-half the carrier frequency, one-third the carrier frequency). In some embodiments, the zero and ninety-degree time-varying switching signals may be generated by the synthesizer, although the scope of the embodiments is not limited in this respect.

In some embodiments, the LO signals may differ in duty cycle (the percentage of one period in which the LO signal is high) and/or offset (the difference between start points of the period). In some embodiments, the LO signals may have an 85% duty cycle and an 80% offset. In some embodiments, each branch of the mixer circuitry (e.g., the in-phase (I) and quadrature phase (Q) path) may operate at an 80% duty cycle, which may result in a significant reduction is power consumption.

The RF input signal 1107 (FIG. 11) may comprise a balanced signal, although the scope of the embodiments is not limited in this respect. The I and Q baseband output signals may be provided to low-noise amplifier, such as amplifier circuitry 1206 (FIG. 12) or to filter circuitry 1208 (FIG. 12).

In some embodiments, the output baseband signals 1207 and the input baseband signals 1211 may be analog baseband signals, although the scope of the embodiments is not limited in this respect. In some alternate embodiments, the output baseband signals 1207 and the input baseband signals 1211 may be digital baseband signals. In these alternate embodiments, the radio IC circuitry may include analog-to-digital converter (ADC) and digital-to-analog converter (DAC) circuitry.

In some dual-mode embodiments, a separate radio IC circuitry may be provided for processing signals for each spectrum, or for other spectrums not mentioned here, although the scope of the embodiments is not limited in this respect.

In some embodiments, the synthesizer circuitry 1204 may be a fractional-N synthesizer or a fractional N/N+1 synthesizer, although the scope of the embodiments is not limited in this respect as other types of frequency synthesizers may be suitable. For example, synthesizer circuitry 1204 may be a delta-sigma synthesizer, a frequency multiplier, or a synthesizer comprising a phase-locked loop with a frequency divider. According to some embodiments, the synthesizer circuitry 1204 may include digital synthesizer circuitry. An advantage of using a digital synthesizer circuitry is that, although it may still include some analog components, its footprint may be scaled down much more than the footprint of an analog synthesizer circuitry. In some embodiments, frequency input into synthesizer circuitry 1204 may be provided by a voltage controlled oscillator (VCO), although that is not a requirement. A divider control input may further be provided by either the baseband processing circuitry 1008a-b (FIG. 10) depending on the desired output frequency 1205. In some embodiments, a divider control input (e.g., N) may be determined from a look-up table (e.g., within a Wi-Fi card) based on a channel number and a channel center frequency as determined or indicated by the example application processor 1010. The application processor 1010 may include, or otherwise be connected to, one of the example secure signal converter 101 or the example received signal converter 103 (e.g., depending on which device the example radio architecture is implemented in).

In some embodiments, synthesizer circuitry 1204 may be configured to generate a carrier frequency as the output frequency 1205, while in other embodiments, the output frequency 1205 may be a fraction of the carrier frequency (e.g., one-half the carrier frequency, one-third the carrier frequency). In some embodiments, the output frequency 1205 may be a LO frequency (fLO).

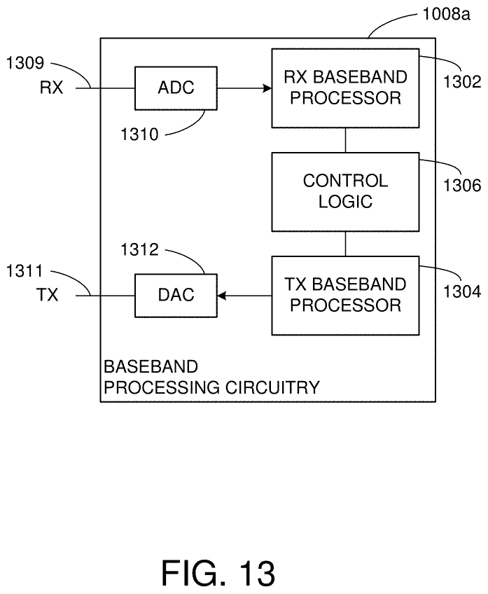

FIG. 13 illustrates a functional block diagram of baseband processing circuitry 1008a in accordance with some embodiments. The baseband processing circuitry 1008a is one example of circuitry that may be suitable for use as the baseband processing circuitry 1008a (FIG. 10), although other circuitry configurations may also be suitable. Alternatively, the example of FIG. 12 may be used to implement the example BT baseband processing circuitry 1008b of FIG. 10.

The baseband processing circuitry 1008a may include a receive baseband processor (RX BBP) 1302 for processing receive baseband signals 1209 provided by the radio IC circuitry 1006a-b (FIG. 10) and a transmit baseband processor (TX BBP) 1304 for generating transmit baseband signals 1211 for the radio IC circuitry 1006a-b. The baseband processing circuitry 1008a may also include control logic 1306 for coordinating the operations of the baseband processing circuitry 1008a.

In some embodiments (e.g., when analog baseband signals are exchanged between the baseband processing circuitry 1008a-b and the radio IC circuitry 1006a-b), the baseband processing circuitry 1008a may include ADC 1310 to convert analog baseband signals 1309 received from the radio IC circuitry 1006a-b to digital baseband signals for processing by the RX BBP 1302. In these embodiments, the baseband processing circuitry 1008a may also include DAC 1312 to convert digital baseband signals from the TX BBP 1304 to analog baseband signals 1311.

In some embodiments that communicate OFDM signals or OFDMA signals, such as through baseband processor 1008a, the transmit baseband processor 1304 may be configured to generate OFDM or OFDMA signals as appropriate for transmission by performing an inverse fast Fourier transform (IFFT). The receive baseband processor 1302 may be configured to process received OFDM signals or OFDMA signals by performing an FFT. In some embodiments, the receive baseband processor 1302 may be configured to detect the presence of an OFDM signal or OFDMA signal by performing an autocorrelation, to detect a preamble, such as a short preamble, and by performing a cross-correlation, to detect a long preamble. The preambles may be part of a predetermined frame structure for Wi-Fi communication.

Referring back to FIG. 10, in some embodiments, the antennas 1001 (FIG. 10) may each comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas may be effectively separated to take advantage of spatial diversity and the different channel characteristics that may result. Antennas 1001 may each include a set of phased-array antennas, although embodiments are not so limited.

Although the radio architecture 105A, 105B is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

The word “exemplary” is used herein to mean “serving as an example, instance, or illustration.” Any embodiment described herein as “exemplary” is not necessarily to be construed as preferred or advantageous over other embodiments. The terms “computing device,” “user device,” “communication station,” “station,” “handheld device,” “mobile device,” “wireless device” and “user equipment” (UE) as used herein refers to a wireless communication device such as a cellular telephone, a smartphone, a tablet, a netbook, a wireless terminal, a laptop computer, a femtocell, a high data rate (HDR) subscriber station, an access point, a printer, a point of sale device, an access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as “communicating,” when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

The term “access point” (AP) as used herein may be a fixed station. An access point may also be referred to as an access node, a base station, an evolved node B (eNodeB), or some other similar terminology known in the art. An access terminal may also be called a mobile station, user equipment (UE), a wireless communication device, or some other similar terminology known in the art. Embodiments disclosed herein generally pertain to wireless networks. Some embodiments may relate to wireless networks that operate in accordance with one of the IEEE 802.11 standards.

Some embodiments may be used in conjunction with various devices and systems, for example, a personal computer (PC), a desktop computer, a mobile computer, a laptop computer, a notebook computer, a tablet computer, a server computer, a handheld computer, a handheld device, a personal digital assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless access point (AP), a wired or wireless router, a wired or wireless modem, a video device, an audio device, an audio-video (A/V) device, a wired or wireless network, a wireless area network, a wireless video area network (WVAN), a local area network (LAN), a wireless LAN (WLAN), a personal area network (PAN), a wireless PAN (WPAN), and the like.

Some embodiments may be used in conjunction with one way and/or two-way radio communication systems, cellular radio-telephone communication systems, a mobile phone, a cellular telephone, a wireless telephone, a personal communication system (PCS) device, a PDA device which incorporates a wireless communication device, a mobile or portable global positioning system (GPS) device, a device which incorporates a GPS receiver or transceiver or chip, a device which incorporates an RFID element or chip, a multiple input multiple output (MIMO) transceiver or device, a single input multiple output (SIMO) transceiver or device, a multiple input single output (MISO) transceiver or device, a device having one or more internal antennas and/or external antennas, digital video broadcast (DVB) devices or systems, multi-standard radio devices or systems, a wired or wireless handheld device, e.g., a smartphone, a wireless application protocol (WAP) device, or the like.

Some embodiments may be used in conjunction with one or more types of wireless communication signals and/or systems following one or more wireless communication protocols, for example, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, single-carrier CDMA, multi-carrier CDMA, multi-carrier modulation (MDM), discrete multi-tone (DMT), Bluetooth®, global positioning system (GPS), Wi-Fi, Wi-Max, ZigBee, ultra-wideband (UWB), global system for mobile communications (GSM), 2G, 2.5G, 3G, 3.5G, 4G, fifth generation (5G) mobile networks, 3GPP, long term evolution (LTE), LTE advanced, enhanced data rates for GSM Evolution (EDGE), or the like. Other embodiments may be used in various other devices, systems, and/or networks.

Example 1 may be a device comprising memory and processing circuitry configured to: identify first packets received from a second device during a time period, the first packets received using a first communication link between the device and the second device; identify second packets received from a third device during the time period, the second packets received using a second communication link between the device and the third device; determine, based on the first packets, a first value indicative of a first amount of channel state variance associated with the first communication link during the time period, wherein the first amount of channel state variance is indicative of first motion between the device and the second device; determine, based on the second packets, a second value indicative of a second amount of channel state variance associated with the second communication link during the time period, wherein the second amount of channel state variance is indicative of second motion between the device and the third device; and cause to send the first value and the second value (e.g., to the second or third device, or to a cloud-based device).

Example 2 may include the device of example 1 and/or some other example herein, wherein the device is a non-access point station device.

Example 3 may include the device of example 2 and/or some other example herein, wherein the processing circuitry is further configured to: determine, based on the first value, a first location associated with the first motion; and determine, based on the second value, a second location associated with the second motion.

Example 4 may include the device of example 1 and/or some other example herein, wherein the processing circuitry is further configured to: cause to send, using the first communication link, third packets to the second device during a second time period after the time period, wherein the third packets are associated with the second device being configured to determine a third value indicative of a third amount of channel state variance associated with the first communication link during the second time period, wherein the third amount of channel state variance is indicative of third motion between the device and the second device.

Example 5 may include the device of example 4 and/or some other example herein, wherein the processing circuitry is further configured to identify a third packet received from an access point, the third packet indicative of a request to send, using the first communication link, the third packets to the second device during the second time period, wherein to cause to send the third packets is based on the request.

Example 6 may include the device of example 1 and/or some other example herein, wherein the processing circuitry is further configured to: cause to send a request to an access point device, the request associated with the access point scheduling first transmissions of the first packets and second transmissions of the second packets, wherein the first packets and the second packets are received in response to the request.

Example 7 may include the device of example 1 and/or some other example herein, wherein the device is an access point, wherein the second device is a first non-access point station device, wherein the third device is a second non-access point station device, and wherein the device, the second device, and the third device form a basic service set.

Example 8 may include the device of example 7 and/or some other example herein, wherein the processing circuitry is further configured to: determine, based on the first value, a first location associated with the first motion; and determine, based on the second value, a second location associated with the second motion.

Example 9 may include the device of example 1 and/or some other example herein, wherein the first and second values are sent to a cloud-based device.

Example 10 may include the device of example 1 and/or some other example herein, further comprising a transceiver configured to transmit and receive wireless signals including the first and second packets.

Example 11 may include the device of example 10 and/or some other example herein, further comprising one or more antennas coupled to the transceiver.

Example 12 may include a non-transitory computer-readable medium storing computer-executable instructions which when executed by one or more processors result in performing operations comprising: identifying, by a first device, first packets received from a second device during a time period, the first packets received using a first communication link between the first device and the second device; identifying, by the first device, second packets received from a third device during the time period, the second packets received using a second communication link between the first device and the third device; determining, based on the first packets, a first value indicative of a first amount of channel state variance associated with the first communication link during the time period, wherein the first amount of channel state variance is indicative of first motion between the first device and the second device; determining, based on the second packets, a second value indicative of a second amount of channel state variance associated with the second communication link during the time period, wherein the second amount of channel state variance is indicative of second motion between the first device and the third device; and causing to send the first value and the second value.

Example 13 may include the non-transitory computer-readable medium of example 12 and/or some other example herein, wherein the first device is a non-access point station device, the operations further comprising: determining, based on the first value, a first location associated with the first motion; and determining, based on the second value, a second location associated with the second motion.

Example 14 may include the non-transitory computer-readable medium of example 12 and/or some other example herein, the operations further comprising: causing to send, using the first communication link, third packets to the second device during a second time period after the time period, wherein the third packets are associated with the second device being configured to determine a third value indicative of a third amount of channel state variance associated with the first communication link during the second time period, wherein the third amount of channel state variance is indicative of third motion between the device and the second device.

Example 15 may include the non-transitory computer-readable medium of example 14 and/or some other example herein, the operations further comprising identifying a third packet received from an access point, the third packet indicative of a request to send, using the first communication link, the third packets to the second device during the second time period, wherein causing to send the third packets is based on the request.

Example 16 may include the non-transitory computer-readable medium of example 12 and/or some other example herein, the operations further comprising: causing to send a request to an access point device, the request associated with the access point scheduling first transmissions of the first packets and second transmissions of the second packets, wherein the first packets and the second packets are received in response to the request.

Example 17 may include the non-transitory computer-readable medium of example 12 and/or some other example herein, wherein the first device is an access point, wherein the second device is a first non-access point station device, wherein the third device is a second non-access point station device, and wherein the first device, the second device, and the third device form a basic service set, the operations further comprising: determining, based on the first value, a first location associated with the first motion; and determining, based on the second value, a second location associated with the second motion.

Example 18 may include a method comprising: identifying, by processing circuitry of a first device, first packets received from a second device during a time period, the first packets received using a first communication link between the first device and the second device; identifying, by the processing circuitry, second packets received from a third device during the time period, the second packets received using a second communication link between the first device and the third device; determining, by the processing circuitry, based on the first packets, a first value indicative of a first amount of channel state variance associated with the first communication link during the time period, wherein the first amount of channel state variance is indicative of first motion between the first device and the second device; determining, by the processing circuitry, based on the second packets, a second value indicative of a second amount of channel state variance associated with the second communication link during the time period, wherein the second amount of channel state variance is indicative of second motion between the first device and the third device; and causing to send, by the processing circuitry, the first value and the second value.

Example 19 may include the method of example 18 and/or some other example herein, wherein the first device is a non-access point station device, the method further comprising: determining, based on the first value, a first location associated with the first motion; and determining, based on the second value, a second location associated with the second motion.

Example, 20 may include the method of example 18 and/or some other example herein, the method further comprising: causing to send, using the first communication link, third packets to the second device during a second time period after the time period, wherein the third packets are associated with the second device being configured to determine a third value indicative of a third amount of channel state variance associated with the first communication link during the second time period, wherein the third amount of channel state variance is indicative of third motion between the device and the second device.

Example 21 may include an apparatus comprising means for: identifying first packets received from a second device during a time period, the first packets received using a first communication link between the first device and the second device; identifying second packets received from a third device during the time period, the second packets received using a second communication link between the first device and the third device; determining, based on the first packets, a first value indicative of a first amount of channel state variance associated with the first communication link during the time period, wherein the first amount of channel state variance is indicative of first motion between the first device and the second device; determining, based on the second packets, a second value indicative of a second amount of channel state variance associated with the second communication link during the time period, wherein the second amount of channel state variance is indicative of second motion between the first device and the third device; and causing to send the first value and the second value.

Example 22 may include one or more non-transitory computer-readable media comprising instructions to cause an electronic device, upon execution of the instructions by one or more processors of the electronic device, to perform one or more elements of a method described in or related to any of examples 1-21, or any other method or process described herein.

Example 23 may include an apparatus comprising logic, modules, and/or circuitry to perform one or more elements of a method described in or related to any of examples 1-21, or any other method or process described herein.

Example 24 may include a method, technique, or process as described in or related to any of examples 1-21, or portions or parts thereof.

Example 25 may include an apparatus comprising: one or more processors and one or more computer readable media comprising instructions that, when executed by the one or more processors, cause the one or more processors to perform the method, techniques, or process as described in or related to any of examples 1-21, or portions thereof.

Example 26 may include a method of communicating in a wireless network as shown and described herein.

Example 27 may include a system for providing wireless communication as shown and described herein.

Example 28 may include a device for providing wireless communication as shown and described herein.

Embodiments according to the disclosure are in particular disclosed in the attached claims directed to a method, a storage medium, a device and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that may direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A device for performing Wi-Fi sensing, the device comprising processing circuitry coupled to storage, the processing circuitry configured to:
identify first packets received from a second device during a time period, the first packets received using a first communication link between the device and the second device;
identify second packets received from a third device during the time period, the second packets received using a second communication link between the device and the third device;
determine, based on the first packets, a first value indicative of a first amount of channel state variance associated with the first communication link during the time period, wherein the first amount of channel state variance is indicative of first motion between the device and the second device;
determine, based on the second packets, a second value indicative of a second amount of channel state variance associated with the second communication link during the time period, wherein the second amount of channel state variance is indicative of second motion between the device and the third device; and
cause to send the first value and the second value.

2. The device of claim 1, wherein the device is a non-access point station device.

3. The device of claim 2, wherein the processing circuitry is further configured to:
determine, based on the first value, a first location associated with the first motion; and
determine, based on the second value, a second location associated with the second motion.

4. The device of claim 1, wherein the processing circuitry is further configured to:
cause to send, using the first communication link, third packets to the second device during a second time period after the time period,
wherein the third packets are associated with the second device being configured to determine a third value indicative of a third amount of channel state variance associated with the first communication link during the second time period, wherein the third amount of channel state variance is indicative of third motion between the device and the second device.

5. The device of claim 4, wherein the processing circuitry is further configured to identify a third packet received from an access point, the third packet indicative of a request to send, using the first communication link, the third packets to the second device during the second time period,
wherein to cause to send the third packets is based on the request.

6. The device of claim 1, wherein the processing circuitry is further configured to:
cause to send a request to an access point device, the request associated with the access point scheduling first transmissions of the first packets and second transmissions of the second packets,
wherein the first packets and the second packets are received in response to the request.

7. The device of claim 1, wherein the device is an access point, wherein the second device is a first non-access point station device, wherein the third device is a second non-access point station device, and wherein the device, the second device, and the third device form a basic service set.

8. The device of claim 7, wherein the processing circuitry is further configured to:
determine, based on the first value, a first location associated with the first motion; and
determine, based on the second value, a second location associated with the second motion.

9. The device of claim 1, wherein the first and second values are sent to a cloud-based device.

10. The device of claim 1, further comprising a transceiver configured to transmit and receive wireless signals.

11. The device of claim 10, further comprising an antenna coupled to the transceiver to perform channel sensing.

12. A non-transitory computer-readable medium storing computer-executable instructions which when executed by one or more processors result in performing operations comprising:
identifying, by a first device, first packets received from a second device during a time period, the first packets received using a first communication link between the first device and the second device;
identifying, by the first device, second packets received from a third device during the time period, the second packets received using a second communication link between the first device and the third device;
determining, based on the first packets, a first value indicative of a first amount of channel state variance associated with the first communication link during the time period, wherein the first amount of channel state variance is indicative of first motion between the first device and the second device;
determining, based on the second packets, a second value indicative of a second amount of channel state variance associated with the second communication link during the time period, wherein the second amount of channel state variance is indicative of second motion between the first device and the third device; and
causing to send the first value and the second value.

13. The non-transitory computer-readable medium of claim 12, wherein the first device is a non-access point station device, the operations further comprising:
determining, based on the first value, a first location associated with the first motion; and
determining, based on the second value, a second location associated with the second motion.

14. The non-transitory computer-readable medium of claim 12, the operations further comprising:
causing to send, using the first communication link, third packets to the second device during a second time period after the time period,
wherein the third packets are associated with the second device being configured to determine a third value indicative of a third amount of channel state variance associated with the first communication link during the second time period, wherein the third amount of channel state variance is indicative of third motion between the device and the second device.

15. The non-transitory computer-readable medium of claim 14, the operations further comprising identifying a third packet received from an access point, the third packet indicative of a request to send, using the first communication link, the third packets to the second device during the second time period,
wherein causing to send the third packets is based on the request.

16. The non-transitory computer-readable medium of claim 12, the operations further comprising:
causing to send a request to an access point device, the request associated with the access point scheduling first transmissions of the first packets and second transmissions of the second packets,
wherein the first packets and the second packets are received in response to the request.

17. The non-transitory computer-readable medium of claim 12, wherein the first device is an access point, wherein the second device is a first non-access point station device, wherein the third device is a second non-access point station device, and wherein the first device, the second device, and the third device form a basic service set, the operations further comprising:
determining, based on the first value, a first location associated with the first motion; and
determining, based on the second value, a second location associated with the second motion.

18. A method for performing Wi-Fi sensing, the method comprising:
identifying, by processing circuitry of a first device, first packets received from a second device during a time period, the first packets received using a first communication link between the first device and the second device;
identifying, by the processing circuitry, second packets received from a third device during the time period, the second packets received using a second communication link between the first device and the third device;
determining, by the processing circuitry, based on the first packets, a first value indicative of a first amount of channel state variance associated with the first communication link during the time period, wherein the first amount of channel state variance is indicative of first motion between the first device and the second device;
determining, by the processing circuitry, based on the second packets, a second value indicative of a second amount of channel state variance associated with the second communication link during the time period, wherein the second amount of channel state variance is indicative of second motion between the first device and the third device; and
causing to send, by the processing circuitry, the first value and the second value.

19. The method of claim 18, wherein the first device is a non-access point station device, the method further comprising:
determining, based on the first value, a first location associated with the first motion; and
determining, based on the second value, a second location associated with the second motion.

20. The method of claim 18, the method further comprising:
causing to send, using the first communication link, third packets to the second device during a second time period after the time period,
wherein the third packets are associated with the second device being configured to determine a third value indicative of a third amount of channel state variance associated with the first communication link during the second time period, wherein the third amount of channel state variance is indicative of third motion between the device and the second device.
